(19) United States
(12) Patent Application Publication
(10) Pub. No.: US 2006/0227221 A1
(43) Pub. Date: Oct. 12, 2006

(54) Image pickup device

(76) Inventor: Mitsumasa Okubo, Hino-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/397,670

(22) Filed: Apr. 4, 2006

(30) Foreign Application Priority Data
Apr. 5, 2005 (JP) 2005-108969
Apr. 5, 2005 (JP) 2005-108970

(51) Int. Cl. H04N 5/228

(52) U.S. Cl. 348/208.2; 348/231.99

(57) ABSTRACT

An image pickup apparatus includes an image pickup unit which obtains image data. A vibration detecting unit detects a vibration. An image restorative function calculating unit calculates an image restorative function. An image restoration unit restores the image data deteriorated by the vibration based on the image restorative function. A recording mode selection unit can select a first recording mode to record the image data which is not subjected to an image restoration process, and image restoring information and a second recording mode to record the image data subjected to the image restoration process. An image recording controller records the image data which is not subjected to the image restoration process in a case where the first recording mode is selected, and the controller records the image data subjected to the image recording process in a case where the second recording mode is selected.

### CROSS-REFERENCE TO RELATED APPLICATIONS

This application is based upon and claims the benefit of priority from prior Japanese Patent Applications No. 2005-108969, filed Apr. 5, 2005; and No. 2005-108970, filed Apr. 5, 2005, the entire contents of both of which are incorporated herein by reference.

### BACKGROUND OF THE INVENTION

1. Field of the Invention

The present invention relates to an image pickup device in which a vibration is detected to restore a blurred image into an image without any blurring.

2. Description of the Related Art

In image pickup devices such as a digital camera and a video camera, there is a demand that an image deteriorated by a vibration during image pickup is corrected to restore an image close to an original image. For example, in the digital camera (hereinafter sometimes referred to simply as the camera), as correction of the vibration in a static image or the like, a technology is known in which a locus of camera shake is detected using an angular velocity sensor or the like, and a predetermined image restoring operation is performed based on the detected locus of shake after the image pickup.

It has been proposed that the vibration be corrected with a point spread function (PSF) in restoring the image without any blurring. When the point spread function is utilized, the image can be comparatively easily restored. Here, as to the restored image corrected with the point spread function, a luminance value of a pixel on a vibration locus is used as a function, but pixel influences other than the vibration locus cannot be ignored. Therefore, the vibration locus calculated from the point spread function does not completely correspond to that of the blurred image, and it is difficult to restore the image accurately.

To solve the problem, for example, in Jpn. Pat. Appln. KOKAI Publication No. 11-134481, the blurred image is restored from the blurred image and the point spread function obtained from vibration locus data. Accordingly, during the restoration, the restored image is produced in consideration of the luminance values of the pixels around the vibration locus. According to this image restoration method, the pixel influences other than the vibration locus are also considered, and a more satisfactory restored image is obtained than before.

### BRIEF SUMMARY OF THE INVENTION

According to a first aspect of the present invention, there is provided an image pickup apparatus comprising:

an image pickup unit which obtains image data from a subject image formed by an optical system;

a vibration detecting unit which detects a vibration of the image pickup apparatus;

an image restorative function calculating unit which calculates an image restorative function from a vibration detecting signal of a time series output from the vibration detecting unit in an exposure period of the image pickup unit;

an image restoration unit which restores the image data deteriorated by the vibration based on the image restorative function output from the image restorative function calculating unit;

a recording mode selection unit to select a first recording mode to record, in a recording medium, the image data which is not subjected to an image restoration process by the image restoration unit and image restoring information corresponding to the image data, and a second recording mode to record the restored image data subjected to the image restoration process by the image restoration unit in the recording medium; and

an image recording controller which records the image data which is not subjected to the image restoration process and the image restoring information in the recording medium in the first recording mode in a case where the first recording mode is selected and which records the restored image data subjected to the image restoration process in the recording medium in the second recording mode in a case where the second recording mode is selected.

According to a second aspect of the present invention, there is provided an image pickup apparatus comprising:

an image pickup unit which obtains image data from a subject image formed by an optical system;

a vibration detecting unit which detects a vibration of the image pickup apparatus;

an image restorative function calculating unit which calculates an image restorative function from a vibration detecting signal of a time series output from the vibration detecting unit in an exposure period of the image pickup unit;

an image restoring information storage unit in which image restoring information is stored;

an image restoration unit which restores the image data deteriorated by the vibration based on the image restorative function output from the image restorative function calculating unit;

an image data storage unit to store the image data which is obtained from the image pickup unit and which is not subjected to the image restoration process by the image restoration unit;

an image recording controller which controls to record in a recording medium the image data, as an image file, which is not subjected to the image restoration process by the image restoration unit, the image recording controller re-recording a restored image data subjected to the image restoration process by the image restoration unit based on the image data which is not subjected to the image restoration process and the image restoring information stored in the image restoring information storage unit after the image data is recorded in the recording medium; and

an operation instructing unit which outputs to the image recording controller an instruction signal to record the restored image data again.

According to a third aspect of the present invention, there is provided an image pickup apparatus comprising:

an image pickup unit which obtains image data from a subject image formed by an optical system;

a vibration detecting unit which detects a vibration of the image pickup apparatus;

an image restorative function calculating unit which calculates an image restorative function from a vibration detecting signal of a time series output from the vibration detecting unit in an exposure period of the image pickup unit;

an image restoration unit which restores the image data deteriorated by the vibration based on the image restorative function output from the image restorative function calculating unit;

an image data storage unit to store the image data which is not subjected to an image restoration process by the image restoration unit;

an image recording controller which records the restored image data subjected to the image restoration process by the image restoration unit as an image file in a recording medium, the image recording controller re-recording the image data which is not subjected to the image restoration process in the recording medium after the restored image file is recorded in the recording medium; and

an operation instructing unit which outputs to the image recording controller an instruction signal to record the image data again.

According to a fourth aspect of the present invention, there is provided an image pickup apparatus comprising:

an image pickup unit which obtains image data from a subject image formed by an optical system;

a vibration detecting unit which detects a vibration of the image pickup apparatus;

an image restorative function calculating unit which calculates an image restorative function from a vibration detecting signal of a time series output from the vibration detecting unit in an exposure period of the image pickup unit;

an image restoration unit which restores the image data deteriorated by the vibration based on the image restorative function output from the image restorative function calculating unit;

a display element which displays the image data; and

a display controller which controls to display in the display element both of the restored image data subjected to the image restoration process by the image restoration unit and the image data which is not subjected to the image restoration process.

According to a fifth aspect of the present invention, there is provided an image pickup apparatus comprising:

an image pickup unit which obtains image data from a subject image formed by an optical system;

a vibration detecting unit which detects a vibration of the image pickup apparatus;

an image restorative function calculating unit which calculates an image restorative function from a vibration detecting signal of a time series output from the vibration detecting unit in an exposure period of the image pickup unit;

an image restoration unit which restores the image data deteriorated by the vibration based on the image restorative function output from the image restorative function calculating unit;

a display element which displays the image data;

a data storage unit to store both of the restored image data subjected to the image restoration process by the image restoration unit and the image data which is not subjected to the image restoration process;

a display controller which controls to display in the display element both of the restored image data stored in the data storage unit and the image data stored in the data storage unit;

an image selection unit to select one of the restored image data and the image data; and

a recording controller which records the image data or the restored image data selected by the image selection unit in a recording medium.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a front surface perspective view of a digital camera in a first embodiment of the present invention;

FIG. 1B is a back surface perspective view of the digital camera in the first embodiment of the present invention;

FIG. 2 is a schematic diagram of a lens unit;

FIG. 3 is a block diagram of a control circuit of the digital camera in the first embodiment;

FIG. 4A is a diagram showing changes of a vibration rotary angle θx in an X-axis direction;

FIG. 4B is a diagram showing changes of a vibration rotary angle θy in a Y-axis direction;

FIG. 4C is a diagram showing a vibration locus in an image pickup device;

FIG. 4D is a diagram showing a relation between an original image and a picked-up image;

FIG. 5 is a main flowchart of a photographing mode in the first embodiment;

FIG. 6 is a flowchart of an image recording process A in FIG. 5;

FIG. 7 is a flowchart of an image recording process B in FIG. 5;

FIG. 8 is a flowchart of an image recording process C in FIG. 5;

FIG. 9 is a diagram showing a structure of an image file of an image recording medium;

FIG. 10 is a flowchart of a reproduction mode in the first embodiment;

FIG. 11 is a flowchart of a reproduction process 1 in FIG. 10;

FIG. 12A is a diagram showing a display example of image data before image restoration;

FIG. 12B is a diagram showing a display example of image data after image restoration;

FIG. 13 is a flowchart of a reproduction process 2 in FIG. 10;

FIG. 14 is a flowchart of an image recording process B in a second embodiment;

FIG. 15 is a flowchart of a reproduction process 1 in the second embodiment;

FIG. 16 is a main flowchart of a photographing mode in a third embodiment;

FIG. 17 is a flowchart of an image switching process in FIG. 16;

FIG. 18 is a main flowchart of a photographing mode in a fourth embodiment;

FIG. 19 is a flowchart of an image recording process A in FIG. 18;

FIG. 20 is a flowchart of an image switching process in FIG. 18;

FIG. 21 is a main flowchart of a photographing mode in a fifth embodiment;

FIG. 22 is a flowchart of an image recording process 1 in FIG. 21;

FIG. 23 is a flowchart of an image recording process 2 in FIG. 21;

FIG. 24A is a diagram showing a display example of image data before image restoration;

FIG. 24B is a diagram showing a display example of image data after image restoration;

FIG. 25 is a diagram showing a structure of an image file of an image recording medium;

FIG. 26 is a flowchart of image selection recording in an image recording process 2 of FIG. 23;

FIG. 27A is a diagram showing an example in which a frame of a restored image is selected in parallel display, and showing that the frame of the restored image is selected;

FIG. 27B is a diagram showing an example in which a frame of a restored image is selected in parallel display, and showing that the frame of an image before restored is selected;

FIG. 27C is a diagram showing a single display image of the selected image frame;

FIGS. 28A, 28B and 28C are diagrams showing display examples of enlargement and reduction of a displayed image;

FIGS. 29A, 29B and 29C are diagrams showing display examples in which the displayed image shifts left and right;

FIG. 30 is a flowchart showing image selection recording in a sixth embodiment;

FIG. 31A is a diagram showing a display example of image data before image restoration;

FIG. 31B is a diagram showing a display example of image data after image restoration;

FIGS. 32A, 32B, 32C and 32D are diagrams showing display examples of enlargement, reduction, and left/right shift of a displayed image;

FIG. 33 is a flowchart of a reproduction mode in a seventh embodiment;

FIG. 34 is a flowchart of a reproduction process 1 in FIG. 33;

FIG. 35 is a flowchart of a reproduction process 2 in FIG. 33;

FIG. 36A is a diagram showing a display example of image data before image restoration; and

FIG. 36B is a diagram showing a display example of image data after image restoration.

### DETAILED DESCRIPTION OF THE INVENTION

Embodiments of the present invention will be described hereinafter with reference to the drawings.

### First Embodiment

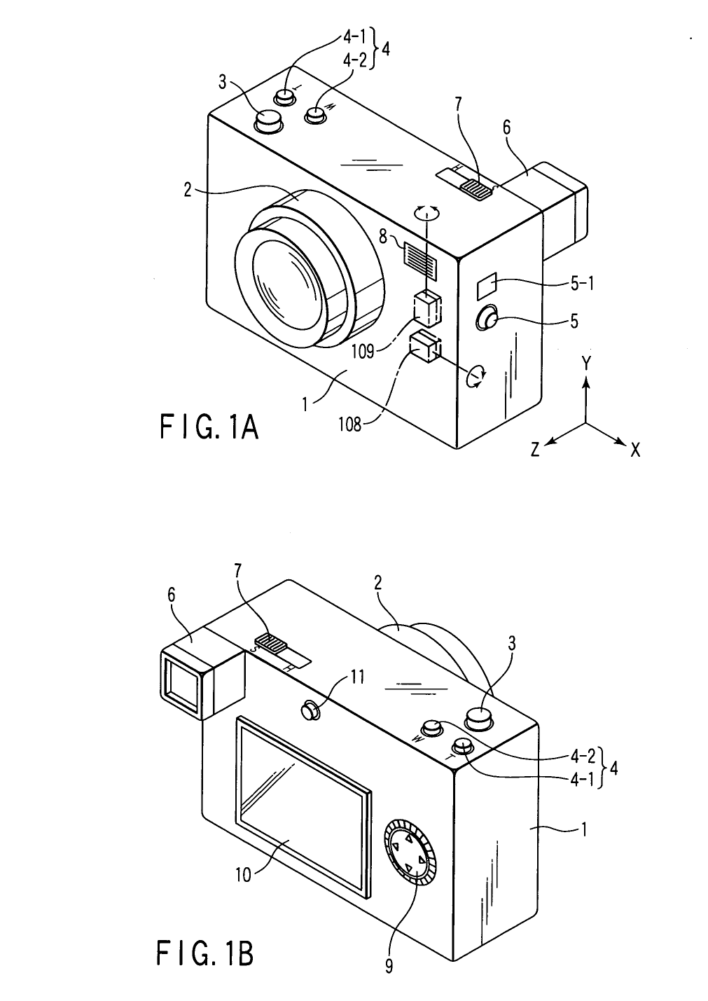

FIG. 1A is a front surface perspective view of a digital camera as one example of an image pickup device in a first embodiment of the present invention, and FIG. 1B is a back surface perspective view of the digital camera as one example of the image pickup device in the first embodiment of the present invention.

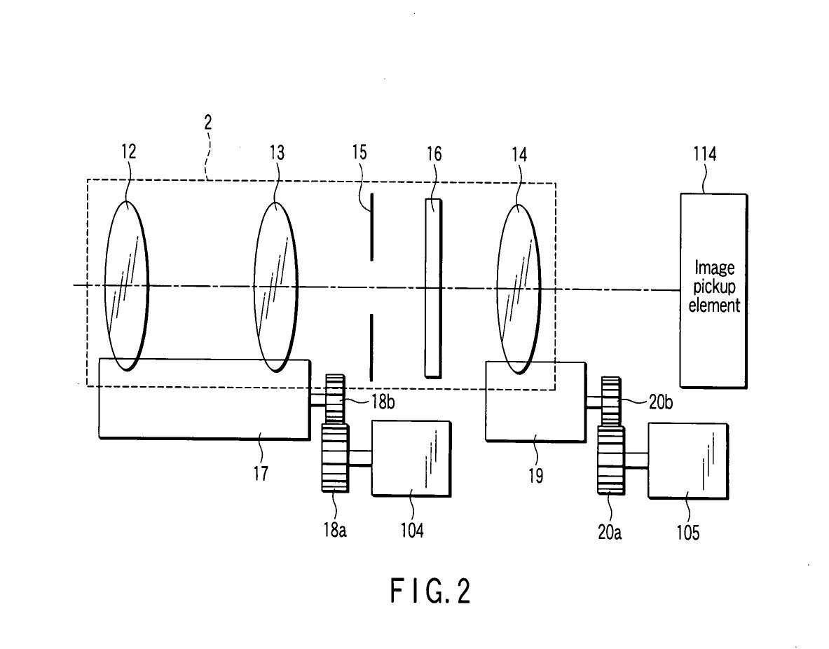

As seen from FIG. 1A, a lens unit 2 is connected to a front surface of a camera body 1. As seen from FIG. 1B, a finder (view finder) 6 is integrally assembled to a back surface of the camera body 1. The lens unit 2 is constituted of a plurality of lens for photography, and a driving section. The lens unit 2 will be described later in detail with reference to FIG. 2.

A release switch 3 is a two-stage switch to be operated by first release (half press) and second release (full press). When the first release switch is turned on, a photographing preparatory operation is started. When the second release switch is turned on, a photographing operation is started. A zoom switch 4 includes a T-button 4-1 and a W-button 4-2. When the T-button 4-1 is pressed, a magnification of the photographing lens is changed to a telescope side. When the W-button 4-2 is pressed, the magnification of the lens is changed to a wide side. When a vibration mode switch 5 is pressed, a mode of the camera is set to a vibration mode. At this time, a mode lamp 5-1 is lit. Accordingly, a photographer sees that the camera is brought into the vibration mode.

The view finder 6 is an electronic view finder which enlarges, for example, a small-sized LCD with a loupe. This view finder 6 can display a through image (referred to also as a “live view”) to display an image of an image pickup element (CCD) in real time. A mode key (sliding key) 7 is a changeover key to a static image or a dynamic image. When the mode key 7 is set to an S-side (STILL), a static image photographing mode is set. When the mode key is set to an M-side (MOVIE), a dynamic image photographing mode is set.

A flash 8 emits light at a time when luminance is low to illuminate a subject. A mode operation key 9 is constituted of four buttons arranged around a determination button. This mode operation key 9 turns on macro photographing, self timer, flash or the like. In a back-surface LCD panel 10, a photographed image is reproduced, and the through image can be displayed. The back-surface LCD panel 10 is utilized as a monitor (display element) together with the view finder 6. The view finder 6 and the back-surface LCD panel 10 are driven and controlled by an LCD driver 133 described later by a control signal from a sequence controller 119. Here, the view finder 6 and the back-surface LCD panel 10 will be appropriately referred to as the LCDs 6, 10. When a power switch 11 is pressed, exposure, image pick-up or the like is possible in the camera.

In the first embodiment, the mode operation key 9 has functions of: a switch which shifts images displayed in the view finder 6 and the back-surface LCD panel 10 from side to side; an image changeover switch which switches an image to an image before or after an image restoration process; and a recording switch for recording the displayed image. Among four peripheral buttons, a right button is a right shift switch which shifts an image to the right, a left button is a left shift switch which shifts the image to the left, and an upper button is an image changeover switch. Moreover, in a case where the image to be recorded is determined, a middle determination button is pressed to record the image. That is, the middle determination button is an image recording switch.

The left and right shift switches, the image changeover switch, and the recording switch may be disposed as independent switches without imparting the functions of the switches to the mode operation key 9.

FIG. 2 is a schematic diagram of the lens unit 2 which is an optical system. The lens unit 2 has, for example, three lenses 12, 13, and 14. Among the three lenses, the lenses 12, 13 are magnification varying lenses (zoom lenses) whose mutual positional relation is changed to thereby change a focal distance of each lens. During zooming, a driving force of a zoom motor 104 is transmitted to a lens driving cam mechanism 17 for zoom via gears 18a, 18b. Moreover, the lenses 12, 13 are moved along an optical axis by the lens driving cam mechanism 17 for zoom.

The lens 14 is a focus lens which moves forwards/backwards along the optical axis to adjust focusing. During focus adjustment, a driving force of a focus motor 105 is transmitted to a lens driving cam mechanism 19 for focus via gears 20a, 20b. Moreover, the lens 14 is moved by the lens driving cam mechanism 19 for focus. An image pickup element (image pickup unit) 114 constituted of, for example, a CCD is positioned behind the lens 14. A light beam passed through the lenses 12, 13, and 14 is formed into an image on the image pick-up element 114, and photoelectrically converted by each pixel of the image pickup element. Accordingly, the image is picked up. A quantity of light (exposure amount) onto the image pickup element 114 is controlled by a aperture 15 and a shutter 16. Instead of the mechanical shutter 16, an element shutter (electronic shutter) of the image pickup element 114 may be used.

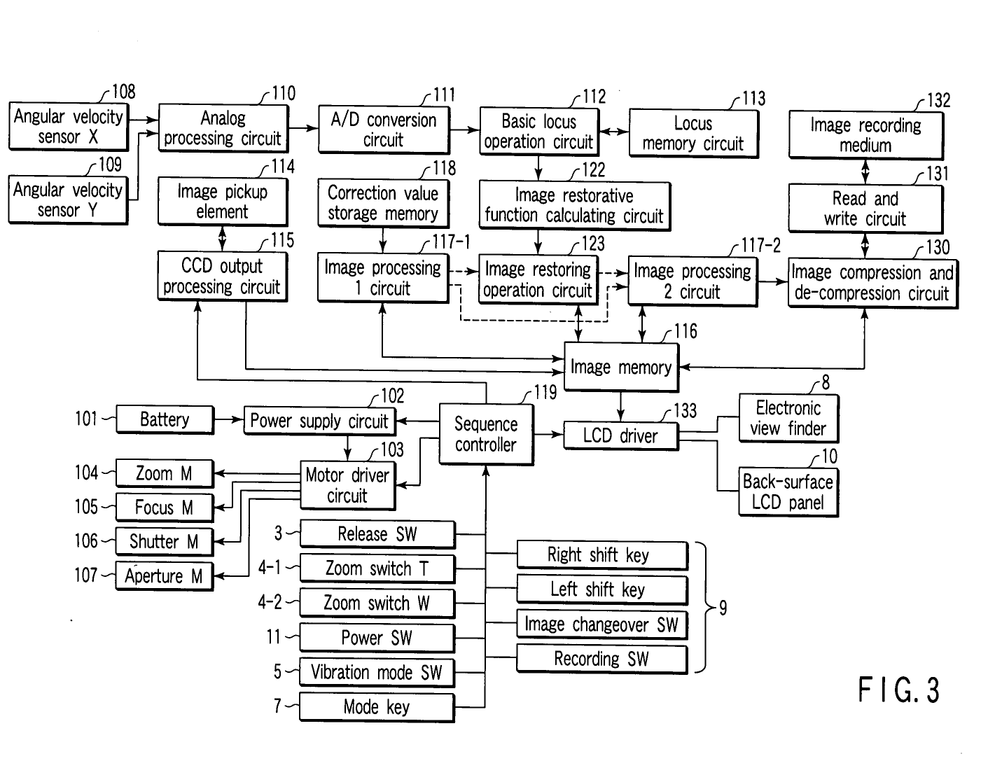

FIG. 3 is a block diagram of a control circuit of the digital camera. A battery 101 includes a chargeable battery such as a lithium ion charging battery. A power supply circuit 102 produces a power source having a voltage required for each processing circuit from a voltage of the battery 101 by a step-up or step-down circuit to supply power to each processing circuit. A motor driver circuit 103 is constituted of an electric circuit including a switching transistor. This motor driver circuit 103 drives and controls the zoom motor 104, the focus motor 105, a shutter motor 106, and a aperture motor 107 in accordance with instructions of a sequence controller 119. Angular velocity sensors 108, 109 detect angular velocities around X-axis and Y-axis which cross each other at right angles. As shown in FIG. 1A, the angular velocity sensors 108, 109 are disposed along axes which are longitudinal directions of elements, and arranged in a direction in which the axes cross each other at right angles to detect angular velocities along the axes.

An analog processing circuit 110 cancels or amplifies offsets of outputs of the angular velocity sensors 108, 109. An output of the analog processing circuit 110 is converted into a digital signal by an A/D conversion circuit 111, and input into a basic locus operation circuit 112. The basic locus operation circuit 112 integrates inputs from the A/D conversion circuit 111 with time to thereby calculate a displacement angle for each time. Moreover, from this displacement angle and focal distance information of the lens unit 2, the circuit calculates a vibration locus in a vertical (Y-direction) or horizontal (X-direction) direction by the vibration of the image in the vicinity of the optical axis on an image pickup plane (on the image pickup element 114). Here, vibration detectors are not limited to the angular velocity sensors 108, 109. Instead of the angular velocity sensors 108, 109, angular acceleration sensors, or a pair of acceleration sensors may be used. A locus memory circuit 113 is a memory which stores a vibration locus (locus data LCT-DT) detected by the basic locus operation circuit 112.

The image pickup element 114 includes a CCD positioned behind the lens unit 2 described with reference to FIG. 2. It is to be noted that the image pickup element 114 is driven and controlled via a CCD driver (not shown) in accordance with a control signal from the sequence controller 119. A CCD output processing circuit 115 processes an output from the image pickup element (CCD) 114. An image memory 116 temporarily holds output data processed in the CCD output processing circuit 115. For example, an SDRAM is used in the image memory 116. An image processing 1 circuit 117-1 subjects the data stored in the image memory 116 to a YC separation process (RGB processing). Furthermore, the circuit also performs processing such as a distortion correcting process or a shading correction process by use of distortion correcting data, shading correction data or the like stored in a correction value storage memory 118.

The sequence controller 119 includes a CPU such as a microcomputer. This sequence controller 119 detects on/off states of the release switch 3, the zoom switches 4 (T, W), the power switch 11, the vibration mode switch 5, the mode key 7 and the like, and the circuit controls movement of each constituent element based on detection results to control the whole digital camera. Since the locus memory circuit 113 stores a vibration restoration detecting signal of a time series in an exposure time, image restoring calculation can be performed after acquiring the image data, and the processing can be executed in order.

An image restorative function calculating circuit 122 is a circuit (image restorative function calculating circuit or unit) which calculates an image restorative function f⁻¹ for restoring the deterioration of the image by the vibration. Here, a change of an original image is predicted from an output of the basic locus operation circuit 112 to calculate the image restorative function f⁻¹. Here, the image restorative function f⁻¹ is a reverse function of an image deteriorative function f generated by the vibration.

Since the lens unit 2 of the digital camera has image distortion which depends on a zoom position and a focal position, the image needs to be corrected. Here, the image distortion is a phenomenon in which an image shape in a peripheral portion of a screen distorts as compared with the center of the screen. The image distortion usually has characteristics such as a barrel shape distortion and a pin-cushion distortion. The shading is a characteristics that a quantity of light drops in the periphery of the screen as compared with the center of the screen depending on the zoom position and the focal position owing to the characteristics of the lens unit 2.

For a distortion correcting process and a shading correction process are performed in the digital camera of the first embodiment, the correction value storage memory 118 stores correction data such as image distortion correction data and shading correction data corresponding to the zoom position and the focal position for each area of the screen. In the following description, the YC separation process, the distortion correcting process, and the shading correction process are referred to as image processing 1. Here, the image processing 1 circuit 117-1 does not execute γ-conversion or image compression which generates a trouble in restoring calculation of a vibrated image. The image data which is not subjected to the γ-conversion or the image compression is sent to an image restoring process circuit 123 and an image processing 2 circuit 117-2.

Here, the γ-conversion is conversion for displacing gradation characteristics of the image data obtained during image pickup in accordance with human visual perception so that the gradation characteristics of the image agree with the human visual perception in a case where the image data is displayed in a monitor or the like, or printed on paper or the like. If the image processing 1 circuit 117-1 executes the γ-conversion, there is a possibility that fundamental linearity of the image data is lost before the image restoration process is executed. Therefore, the γ-conversion is executed after the image restoration process. Since the image restoration process cannot be executed with respect to compressed image data, the image processing 1 circuit 117-1 does not perform the compression process, and the compression process is performed after the image restoration process.

The image data which is not subjected to the γ-conversion or the image compression is sent from the image processing 1 circuit 117-1 to the image restoring operation circuit 123. The image restoring operation circuit 123 performs image restoring calculation by use of the image restorative function f⁻¹ calculated for each area of the screen in the image restorative function calculating circuit 122. With regard to an image from which an influence of the distortion or the shading has been eliminated to restore the image deteriorated by the vibration in the image restoring operation circuit 123, the image processing 2 circuit 117-2 subjects the image to the γ-conversion (image processing 2), and the data is further compressed by an image compression and de-compression circuit 130. Thereafter, the data is written into an image recording medium 132 by a read and write circuit 131. The writing of the data into the image recording medium 132 by the read and write circuit 131 is controlled by a control signal from the sequence controller 119. That is, the sequence controller 119 also functions as a recording controller.

Here, as the image recording medium 132, a built-in memory such as a built-in flash memory, or an external memory such as a charging type memory card is applied. When the image data processed by the image restoring operation circuit 123 is recorded in the image recording medium 132, for example, the built-in flash memory or the external memory (e.g., charging type memory card), sharp image data in the whole screen can be recorded. Here, the read and write circuit 131 functions as a write and read unit of compressed image data.

The image compression and de-compression circuit 130 also has an de-compressing function for displaying the image data read from the image recording medium 132 by the read and write circuit 131 in the view finder 6 and the back-surface LCD panel 10. The image compression and de-compression circuit 130 reads and de-compresses compressed image data obtained by compressing the image data and further recorded in the image recording medium 132, and the circuit displays the data in the LCDs 6, 10 (view finder 6, back-surface LCD panel 10). Here, the image processing 1 circuit 117-1, the image restoring operation circuit 123, the image processing 2 circuit 117-2, and the image compression and de-compression circuit 130 are connected to the image memory 116, and the image memory 116 functions as a memory (buffer memory) for temporarily holding the image data processed by these circuits.

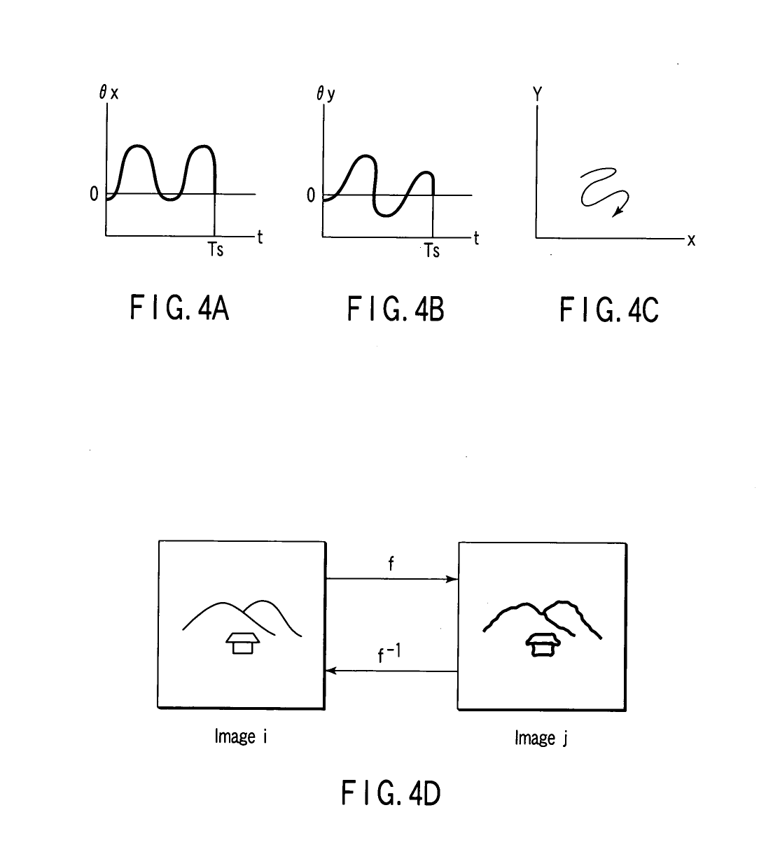

Next, electronic vibration correcting in the static image will be described. FIGS. 4A to 4D are diagrams showing concepts of the electronic vibration correcting in the static image. More specifically, FIG. 4A is a diagram showing changes of a vibration rotary angle θx in an X-axis direction, FIG. 4B is a diagram showing changes of a vibration rotary angle θy in a Y-axis direction, FIG. 4C is a diagram showing a vibration locus in the image pick-up element (CCD) 114, and FIG. 4D is a diagram showing a relation between an original image and a picked-up image.

As described with reference to FIG. 3, with regard to the vibrations of the X-axis and the Y-axis, detected by the angular velocity sensors 108, 109, data of the displacement angles θx, θy are output to the basic locus operation circuit 112 in accordance with time, that is, in a time series as shown in FIGS. 4A and 4B. Next, since a focal distance of the lens is seen from the zoom position at a time when the data of the displacement angles θx, θy are output, as shown in FIG. 4C, a displacement locus of the vibration on the image pickup element (CCD) 114 is calculated by paraxial calculation. This vibration displacement locus is stored in the locus memory circuit 113. Moreover, the image deteriorative function f by the vibration is calculated from the vibration locus on the image pickup element 114 stored in the locus memory circuit 113. Here, it is seen from the image deteriorative function f that a picked-up image (original image) i is deteriorated into a blurred image j. Therefore, the reverse function f⁻¹ of f, that is, the image restorative function can be obtained. This picked-up image which is not influenced by the vibration is restored by inversion by use of the image restorative function f⁻¹.

As described above, as to the static image, the image deteriorative function f is calculated from the vibration locus on the image pickup element 114 based on the time-series vibration by the vibration during photographing, and the blurred image is corrected by the inversion by the reverse function f⁻¹ of f, that is, the image restorative function.

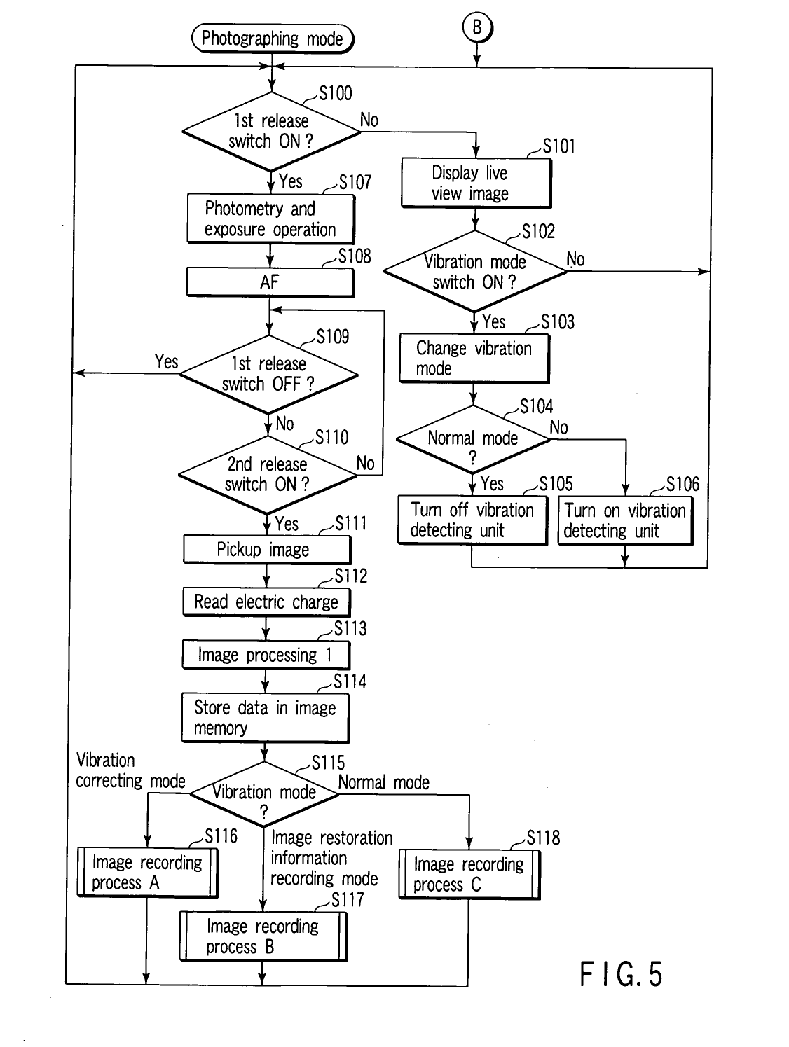

FIG. 5 shows a main flowchart of a photographing mode. First, when the power switch 11 is pressed, a lens having a depressed state is set up, and it is judged whether or not the first release switch has been turned on (S100). The image pickup element (CCD) 114 continuously operates in a predetermined period until the first release switch is turned on. The resultant image data (live view image i.e. image picked-up in real time for display) is displayed in the view finder 6 and the back-surface LCD panel 10 (S101). When the first release switch is turned on in S100, photometry is performed by a photometry sensor (not shown), and a photometry and exposure operation is performed based on photometry results (S107). Furthermore, a distance measuring sensor (not shown) performs distance measuring, and the focus motor 105 is driven and controlled based on the distance measuring result. Accordingly, the focusing lens 14 is driven to perform automatic focusing (AF) (S108).

Furthermore, it is judged whether or not the first release switch of the release switch 3 has been turned off (S109). When a first release operation is discontinued to stop a photographing operation, the processing returns to S100. If the first release switch is turned on in S109, it is next judged whether or not the second release switch has been turned on (S110). Unless the second release switch is turned on, the processing returns to S109 to judge whether or not the first release switch has been turned off. If the second release switch is turned on in S110, the image pickup element (CCD) 114 is operated to perform the photographing. That is, an exposure operation (image pickup) is performed (S111), an electric charge accumulated in the image pickup element (CCD) 114 is photoelectrically converted, and the image data is read via the CCD output processing circuit 115 (S112). Moreover, the image processing 1 circuit 117-1 performs image processing 1 such as the YC separation process, the distortion correction, and the shading correction (S113). Thereafter, the image data (referred to as DTR) subjected to the image processing 1 is stored in the image memory 116 (S114).

Next, a vibration mode is judged (S115). In a vibration correction mode in which an image restoration process is executed during the image pickup, an image recording process A is performed with respect to the image data (DTR) subjected to the image processing 1 and stored in the image memory 116 (S116). Any image is not restored during the image pickup, but an image recording process B is performed in a mode (image restoring information recording mode) in which image restoring information is recorded in preparation for the image restoration process after the image pickup (S117). An image recording process C is performed in a mode (referred to as the normal mode) in which the image restoration process is not required during or after the image pickup (S118).

It is to be noted that a first recording mode corresponds to the image restoring information recording mode (image recording process B), a second recording mode corresponds to the vibration correcting mode (image recording process A), and a third recording mode corresponds to the normal mode (image recording process C).

When the image data (live view image) is displayed in S101, it is judged whether or not the vibration mode switch 5 has been turned on. When the vibration mode switch 5 is pressed, the vibration mode is changed (S103). It is next judged whether or not the presently selected vibration mode is the normal mode (S104).

The angular velocity sensors 108, 109 as vibration detecting units constantly operate. However, the normal mode is a mode (third recording mode) which does not requires the image restoration process. Therefore, in the normal mode, the angular velocity sensors 108, 109 are turned off (S105), and the processing returns to S100. In a mode (first and second recording modes) output terminal the normal mode (third recording mode), the image restoring information is required. Therefore, the vibration detecting unit (angular velocity sensors 108, 109) remains to be on (S106). The processing returns to S100, thereby similarly waiting ready.

In S102 to judge whether or not the vibration mode switch 5 has been turned on, when the vibration mode switch 5 is off, the processing immediately returns to S100.

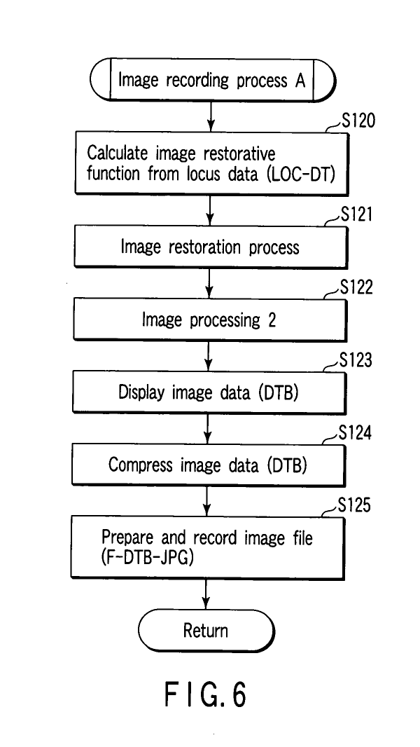

FIGS. 6, 7, and 8 show flowcharts of image recording processes A, B, and C which are sub-routines, respectively. In the flowchart of the image recording process A shown in FIG. 6, the image restorative function calculating circuit 122 calculates the image restorative function based on the locus data (LOC-DT) stored in the locus memory circuit 113 (S120). An image restoration process is executed on the image data (DTR) subjected to the image processing 1 and stored in the image memory 116 based on this calculated image restorative function (S121). The image data subjected to the image restoration process is γ-converted (image processing 2) by the image processing 2 circuit 117-2 (S122). Moreover, image data (referred to as DTB) subjected to the image processing 2 is displayed in the LCDs 6, 10 (view finder 6, back-surface LCD panel 10) (S123).

Moreover, the image data (DTB) is compressed in a compression format in conformity with JPEG by the image compression and de-compression circuit 130 (S124). Thereafter, the compressed image data (DTB-JPG) is combined with the locus data (LOC-DT) to prepare an image file (F-DT-JPG), and the file is recorded in the image recording medium 132 (S125).

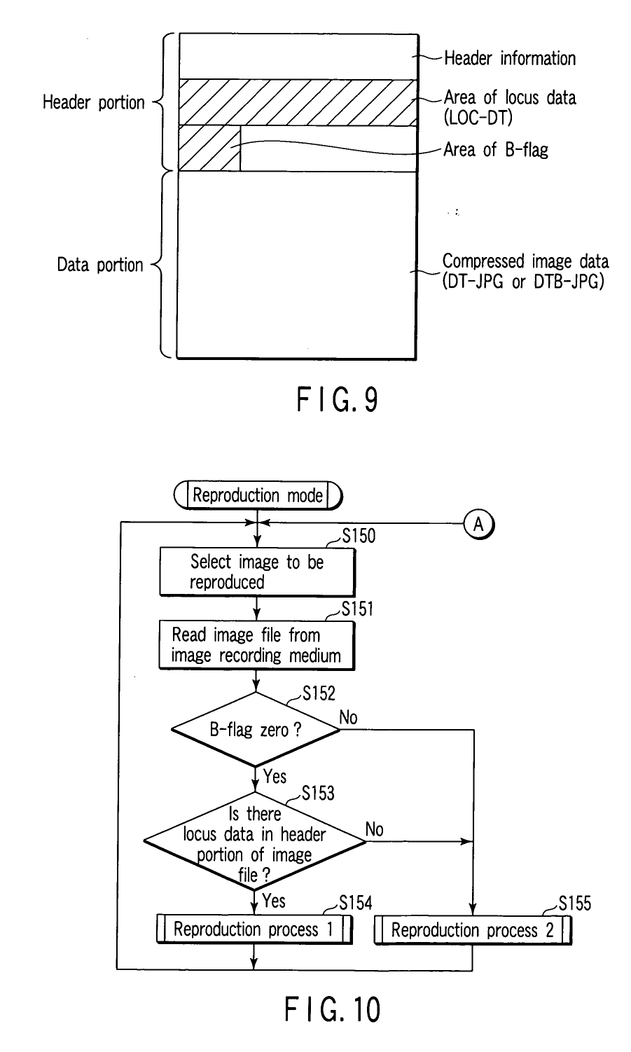

FIG. 9 is a diagram showing a structure of an image file. The image file includes: a data portion in which the compressed image data (DTB-JPG) is recorded; and a header portion including the locus data (LOC-DT), header information (image pickup parameter, standard information of image data, etc.) accompanying the image file, and a B-flag which is a flag indicating whether or not the image file has been subjected to the image restoration process. Moreover, the compressed image data is recorded in the data portion of the image file, and the locus data (LOC-DT) is recorded in the header portion. When the image file is an image file (F-DTB-JPG) subjected to the image restoration process, the B-flag indicates 1. As to an image file (F-DT-JPG) which is not subjected to the image restoration process, the B-flag indicates 0.

In the image recording process A, since the image file (F-DT-JPG) including the image data subjected to the image restoration process is recorded, the image is not restored in postprocessing after the image pickup. Therefore, in this respect, the locus data (LOC-DT) does not have to be recorded during the recording. However, the locus data (LOC-DT) is also recorded so that a degree of vibration can be confirmed after the image pickup.

In S125, the compressed image data is recorded in the data portion of the image file, and the locus data (LOC-DT) is recorded in the header portion. Since the image file is an image file (DTB-JPG) subjected to the image restoration process in the image recording process A, the B-flag of the header portion of the image file is recorded. In this case, the flag indicates 1 (subjected to the image restoration process).

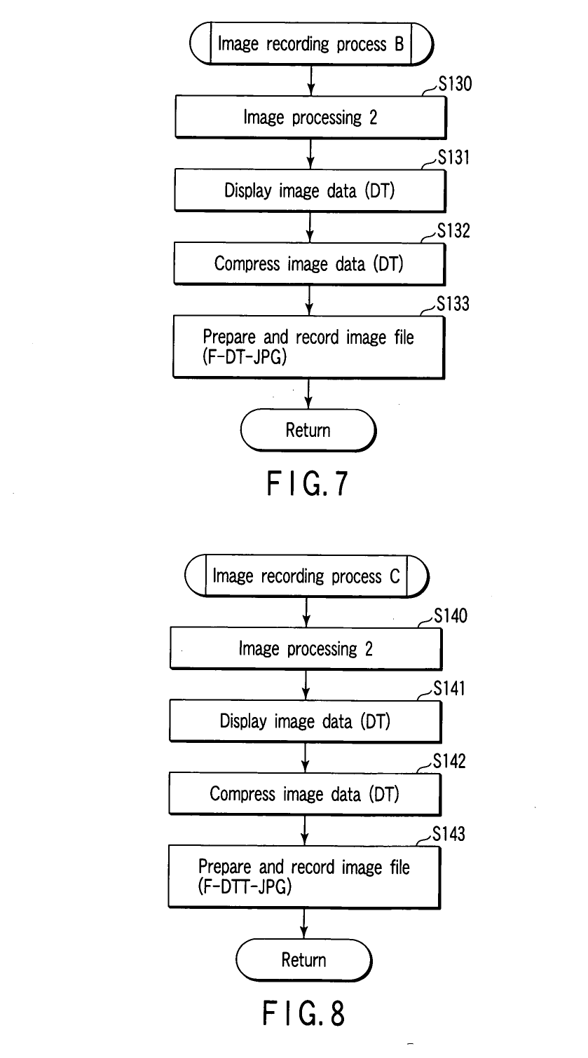

In the flowchart of the image recording process B shown in FIG. 7, first the image data (DTR) stored in the image memory 116 is read. Moreover, the data is γ-converted (image processing 2) by the image processing 2 circuit 117-2 (S130), and the image data (referred to as DT) subjected to the image processing 2 is displayed in the LCDs 6, 10 (S131). Moreover, the image data (DT) is compressed by a compression format conforming to the JPEG by the image compression and de-compression circuit 130 (S132). Since a future (after the image pickup) image restoration process is considered in the image recording process B, the compressed image data (DT-JPG) is combined with the locus data (LOC-DT) to prepare an image file (F-DT-JPG), and the file is recorded in the image recording medium 132 (S133).

In S133, the compressed image data (DT-JPG) is recorded in the data portion of the image file, and the locus data (LOC-DT) is recorded in the header portion. The image file is an image file (F-DT-JPG) which is not subjected to the image restoration process in the image recording process B. Therefore, the B-flag of the header portion of the image file, indicating 0 (without any image restoration process), is recorded.

Since the image data and image restoration information of the image data are recorded as one image file, the image file can be handled as one group of image file, and the file is easily handled. Especially, as described later, the image restoration process is easily performed in the postprocessing.

The flowchart of the image recording process C shown in FIG. 8 is equal to the flowchart (FIG. 6) of the image recording process B except that the locus data (LOC-DT) is not recorded. That is, the image data (DTR) stored in the image memory 116 is read, the data is γ-converted (image processing 2) by the image processing 2 circuit 117-2 (S140), and the image data (DT) subjected to the image processing 2 is displayed in the LCDs 6, 10 (S141). Moreover, the image data (DT) is compressed by the compression format conforming to the JPEG by the image compression and de-compression circuit 130 (S142). The image file is prepared from the compressed image data, and recorded in the image recording medium 132 (S143). Since the future (after the image pickup) image restoration process is not considered in the image recording process C, the locus data (LOC-DT) is not recorded. This image file (F-DTT-JPG) which does not involve this locus data (LOC-DT) is distinguished from the image file (F-DT-JPG) involving the locus data (LOC-DT).

The compressed image data (DT-JPG) is recorded in the data portion of the image file, and the image file is an image file (F-DTT-JPG) which is not subjected to the image restoration process. Therefore, the B-flag of the header portion of the image file, indicating 0 (without any image restoration process), is recorded.

In a case where a mode (normal mode) which does not require any image restoration process is selected to perform the image recording process C either during or after the image pickup, it is possible to execute a mode which does not require any image restoration process. Moreover, when the normal mode is selected, any process relating to image restoration is not required. Therefore, power consumption is reduced. Therefore, the normal mode can be referred to as a power saving mode. Moreover, an operation time is shortened, and continuous image pickup is possible with less waiting time.

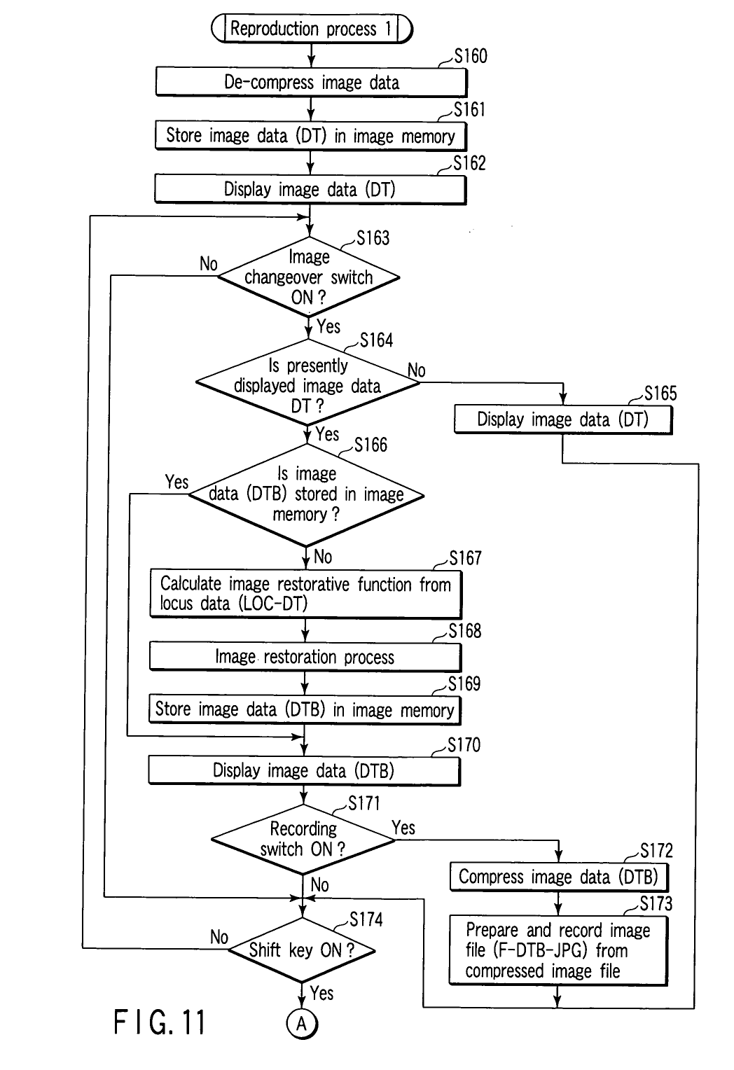

FIG. 10 shows a flowchart of a reproduction mode. In a reproduction screen, when it is detected that a right or left shift key is turned on, the image data is changed, and image data is selected as an object of reproduction (S150). Moreover, the image file of the selected image data is read from the image recording medium 132 by the read and write circuit 131 (S151).

The compressed image data is recorded in the data portion of the image file, and there are recorded: the locus data (LOC-DT); header information (image pickup parameter, standard information of the image data, etc.) accompanying the image file; and B-flag which is a flag indicating the presence of the image restoration process in the header portion of the image file. When the image file is an image file (F-DTB-JPG) subjected to the image restoration process, the B-flag indicates 1. In a case where the image file is an image file (F-DT-JPG) which is not subjected to the image restoration process, the B-flag indicates 0.

It is judged whether or not the image file is an image file (F-DT-JPG) which is not subjected to the image restoration process by judging whether or not B-flag=0 (S152). This type of judgment is performed by the sequence controller 119. If the B-flag indicates 0, and the image file is not subjected to the image restoration process (F-DT-JPG), it is judged whether or not the locus data (LOC-DT) is recorded in the header portion of the image file (S153). When the locus data (LOC-DT) is recorded, the data is reproduced by a reproduction process 1 (S154). When any locus data (LOC-DT) is not recorded, the data is reproduced by a reproduction process 2 (S155). When the B-flag indicates 1, and the image file is subjected to the image restoration process (F-DTB-JPG) in S152, the reproduction is performed by the reproduction process 2 (S155). When the reproduction processes 1, 2 are completed, the processing returns to S150 to select the next image data as the object of the reproduction.

The image is reproduced by the reproduction process 1 after the image recording process B, and the image is reproduced by the reproduction process 2 after the image recording processes A, C.

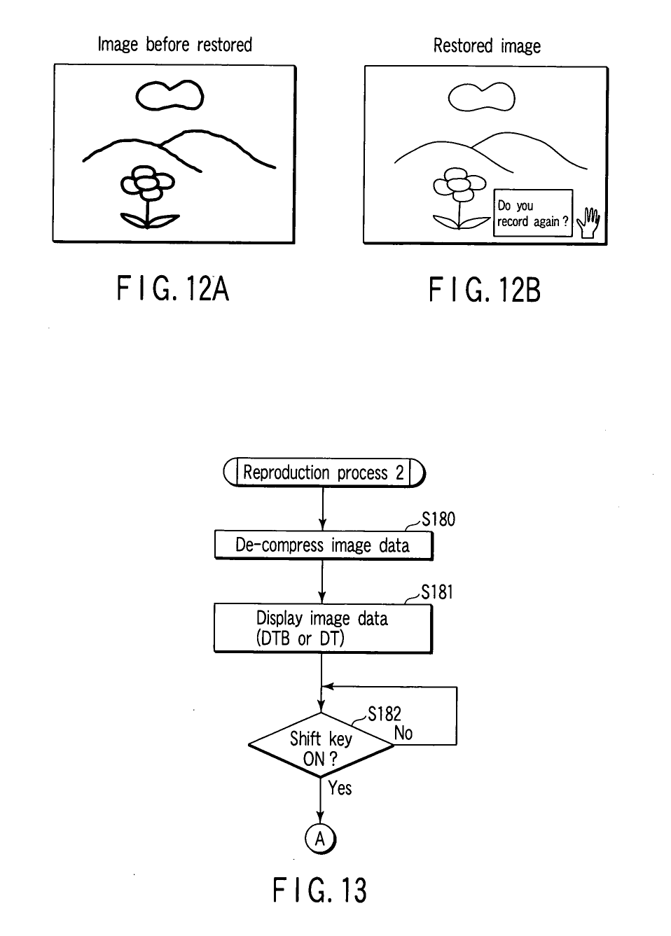

FIG. 11 is a flowchart of the reproduction process 1. First, the selected image data is read from the image memory 116, and de-compressed by the image compression and de-compression circuit 130 (S160). In the reproduction process 1, the image data before subjected to the image restoration process is an object. Therefore, the de-compressed image data is image data (DT). This image data (DT) is stored in the image memory 116 (S161). Moreover, the image data (DT) is read, and displayed in the LCDs 6, 10 (view finder 6, back-surface LCD panel 10) as shown in FIG. 12A (S162).

Next, it is judged whether or not the image changeover switch has been turned on (S163). When the image changeover switch is off, the processing shifts to S174 to judge whether the left shift key or the right shift key has been turned on. When the shift key is pressed, the mode returns to the reproduction mode. When the key is not pressed, the processing returns to S163.

When the image changeover switch is pressed in S163, it is judged whether or not the image data being displayed is image data (DT) (S164). When the data is not the image data (DT), and the data is the image data (DTB) subjected to the image restoration process, the image data (DT) stored in the image memory 116 is read, and the image data (DT) is displayed (S165). Next, the processing shifts to S174 to judge whether the left shift key or the right shift key has been turned on. When the shift key is pressed, the mode returns to the reproduction mode, and the data changes to the next data. If the key is not pressed, the processing returns to S163 to continue the reproduction process.

When it is judged in S164 that the image data being displayed is the image data (DT) before subjected to the image restoration, it is judged whether or not the corresponding image data (DTB) subjected to the image restoration is stored in the image memory 116 (S166). Unless the image data (DTB) subjected to the image restoration is stored in the image memory 116, the image needs to be restored. Therefore, the image restorative function calculating circuit 122 calculates the image restorative function based on the locus data (LOC-DT) (read from the image recording medium in S151) (S167). Next, the image data (DT) is sent to the image restoring operation circuit 123, and the image restoring operation circuit 123 executes the image restoration process based on the image restorative function calculated by the image restorative function calculating circuit 122 (S168).

Since the image data (DT) before subjected to the image restoration and the locus data (LOC-DT) of the image data are recorded as one image file, the data can be handled as one group of image file, and the image restoration process is easily performed in the reproduction mode.

Thereafter, the image data (DTB) subjected to the image restoration process is stored in the image memory 116 (S169). Moreover, the display of the image data (DT) is switched to that of the image data (DTB), and the image data (DTB) is displayed in the LCDs 6, 10 as shown in FIG. 12B (S170).

That is, the image data (DT) before subjected to the image restoration and the image data (DTB) subjected to the image restoration are alternately displayed in the reproduction mode by switching the image changeover switch as shown in FIGS. 12A and 12B. Therefore, when the image data (DT) before the image restoration and the image data (DTB) subjected to the image restoration are switched and displayed, an effect of the image restoration can be confirmed at any time after the image pickup. When the image data (DT) before subjected to the image restoration is compared with the image data (DTB) subjected to the image restoration, a photographer can recognize photographer's vibration level (a degree of generated vibration).

Next, it is judged whether or not the recording switch has been turned on (S171). When the recording switch is turned on for re-recording, the image data (DTB) is compressed in the compression format conforming to the JPEG by the image compression and de-compression circuit 130 (S172). Moreover, the compressed image data (DTB-JPG) is combined with the locus data (LOC-DT) to prepare an image file (F-DTB-JPG), and the file is overwritten (recorded again) in the image recording medium 132 (S173). As shown in FIG. 12B, the re-recording is urged in the display of the image data (DTB). For example, when “Do you record again?” is displayed, the re-recording can be prevented from being forgotten. When the image data (DTB) subjected to the image restoration process does not have to be recorded (re-recorded), and the recording switch is not turned on in S171, it is judged in S171 whether or not the shift key has been turned on. When the shift key is pressed, the mode returns to the reproduction mode. When the key is not pressed, the processing returns to S163 to repeat the processing of and after S164. Here, the overwriting (re-recording) into the image recording medium 132 is performed under control and instruction of the sequence controller 119.

Since the image data (DTB) is not stored in the image memory 116 first time in S166, the processing of S167 to S169 needs to be executed. However, since the image data (DTB) is already recorded second time and thereafter, the processing of S167 to S169 is omitted. In this case, the processing shifts to S170, and the display of the image data (DT) is instantly switched to that of the image data (DTB).

Since the image data (DT) before subjected to the image restoration is recorded together with image restoration information such as the locus data (LOC-DT) in this manner, the image restoration process is possible in postprocessing after the image pickup, such as the reproduction process. Therefore, the image restoration process which requires much time can be omitted during the image pickup, and the image can be quickly photographed without missing any shutter timing.

Moreover, since the locus data (LOC-DT) based on a vibration detecting signal of a time series in an exposure period is used as the image restoring information, the image restoring operation is performed after the image data is acquired, and the image restoration process can be executed in order.

Furthermore, even after the image data which is not subjected to the image restoration process is recorded, the image restoration process is executed on the image data that is not subjected to the image restoration process, and the image data subjected to the image restoration process can be recorded again. Additionally, since the image data is switched and displayed before and after the image restoration process, the image data before the image restoration process can be compared with that after the process to confirm the effect of the image restoration process. Accordingly, after the effect is confirmed, the image data subjected to the image restoration process can be recorded again.

FIG. 13 shows a flowchart of a reproduction process 2. First, the selected image data is de-compressed by the image compression and de-compression circuit 130 (S180). In the reproduction process 2, the image data photographed and recorded in the image recording processes A, C, is an object. The image data (DTB) subjected to the image restoration process is an object in the image recording process A. In the image recording process C, the image data (DT) which is not subjected to the image restoration is an object. Moreover, the image data (DTB) or the image data (DT) is displayed in the LCDs 6, 10 (view finder 6, back-surface LCD panel 10) (S181). As to the image data photographed and recorded in the image recording processes A, C, any image restoration process is not required in the reproduction mode. Therefore, it is instantly judged whether or not the shift key has been turned on (S182). When the shift key is pressed, the mode returns to the reproduction mode. When the key is not pressed, the processing is on standby until the key is pressed.

When the image recording process A is selected, and the image data subjected to the image restoration process is recorded during the image pickup, the image data subjected to the image restoration process is reproduced with a simple operation, and the image data subjected to the image restoration process can be quickly and easily viewed.

Instead of switching and displaying both of the image data (DT) before subjected to the image restoration and the image data (DTB) after the image restoration, parallel display may be performed in which a display screen is divided into, for example, equal right and left portions, and the image data (DT) before subjected to the image restoration and the image data (DTB) subjected to the image restoration are displayed in the right and left screens, respectively. According to this parallel display, the image data (DT) before subjected to the image restoration can be directly compared with the image data (DTB) after the image restoration, the image restoration effect can be visually confirmed. Therefore, effective confirmation is possible.

### Second Embodiment

In the first embodiment, locus data (LOC-DT) calculated from a vibration detecting signal of a time series in an exposure period and stored in a locus memory circuit 113 is used as image restoring information. On the other hand, in a second embodiment, an image restorative function calculated based on the locus data (LOC-DT) is used as the image restoring information instead of the locus data (LOC-DT).

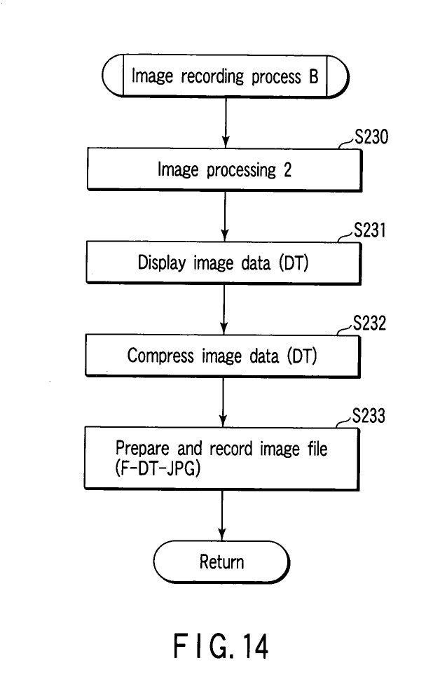

FIG. 14 is a flowchart of an image recording process B in the second embodiment. Steps S230 to S233 of the second embodiment correspond to the steps S130 to S133 of the first embodiment shown in FIG. 7. FIG. 14 is different from FIG. 7 only in that the image restorative function is recorded as the image restoring information in S233.

The image data stored in an image memory 116 is read, and image processing 2 (γ-conversion) is executed (S230). Thereafter, image data (DT) subjected to the image processing 2 is displayed (S231). Next, the image data (DT) is compressed in a compression format conforming to the JPEG by an image compression and de-compression circuit 130 (S232). Moreover, the compressed image data (DT-JPG) is combined with the image restorative function calculated by the image restorative function calculating circuit 122 based on the locus data (LOC-DT) stored in a locus memory circuit 113 to prepare an image file (F-DT-JPG), and the file is recorded in an image recording medium 132 (S233). The image data is recorded in a data portion of the image file, and the image restorative function and a B-flag are recorded in a header portion of the image file. Since the image data is image data (DT-JPG) that is not subjected to any image restoration process, the B-flag is recorded as 0.

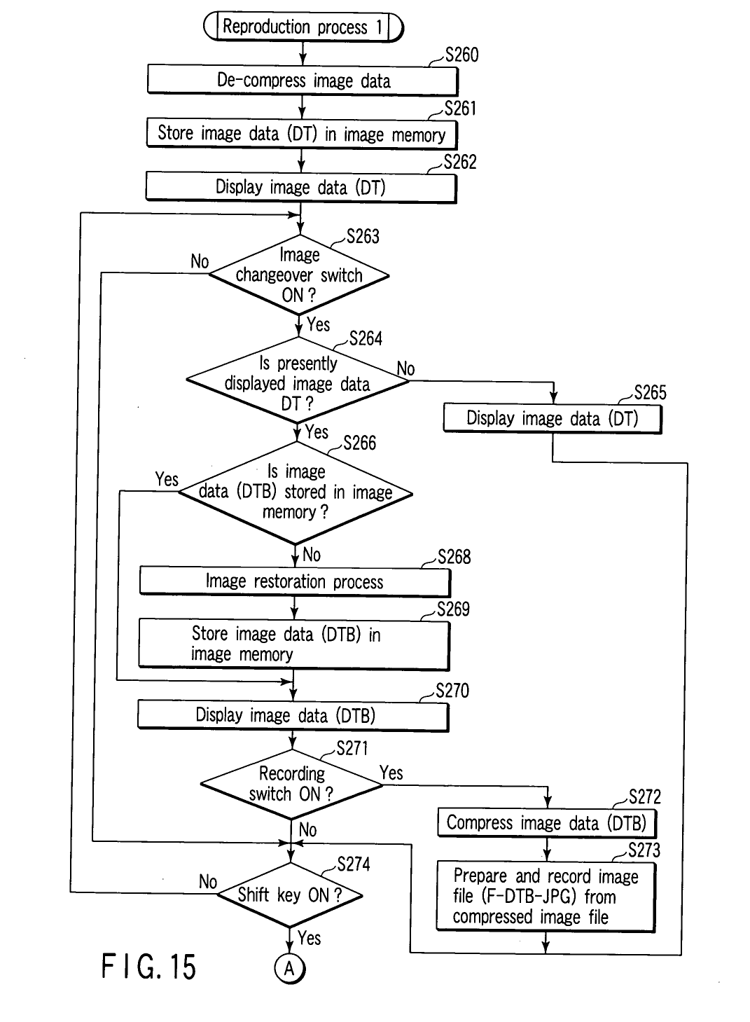

FIG. 15 shows a flowchart of a reproduction process 1 in the second embodiment. Steps S260 to S266 and S268 to S274 of FIG. 15 correspond to the steps S160 to S166 and S168 to S174 of the first embodiment shown in FIG. 11. FIG. 15 is different only in that a step corresponding to the S167 of the first embodiment is omitted.

That is, when image data being displayed in S264 is image data (DT) before subjected to the image restoration, it is judged whether or not the corresponding image data (DTB) subjected to the image restoration is stored in the image memory 116 (S266). Here, when the image data (DTB) is not stored in the image memory 116, an image restoring operation circuit 123 executes the image restoration process with respect to the image data (DT) before subjected to the image restoration based on an image restorative function read from the image recording medium 132 (S268). Here, the image restorative function is recorded in a header portion of an image file recorded in the image recording medium 132. Since steps S260 to S266 and S268 to S274 correspond to the steps S160 to S166 and S168 to S174 of the first embodiment shown in FIG. 11, description thereof is omitted.

In the first embodiment, the image restoring information is calculated from the vibration detecting signal of the time series in the exposure period, and the information is stored as the locus data (LOC-DT) in the locus memory circuit 113. On the other hand, in the second embodiment, the image restoring information is the image restorative function. Since another constitution is common go the first embodiment, description of the common constitution of the second embodiment is omitted.

Even in the second embodiment, the image data before the image restoration is recorded together with the image restoring information. Therefore, the image restoration process is possible in postprocessing after image pickup. Moreover, since the image restorative function is used as the image restoring information, the image restoration process can be quickly performed with respect to the image data that is not subjected to the image restoration process, for example, after acquiring image data such as a reproduction mode after the image pickup. Therefore, the image data subjected to the image restoration process can be acquired at any time if necessary.

### Third Embodiment

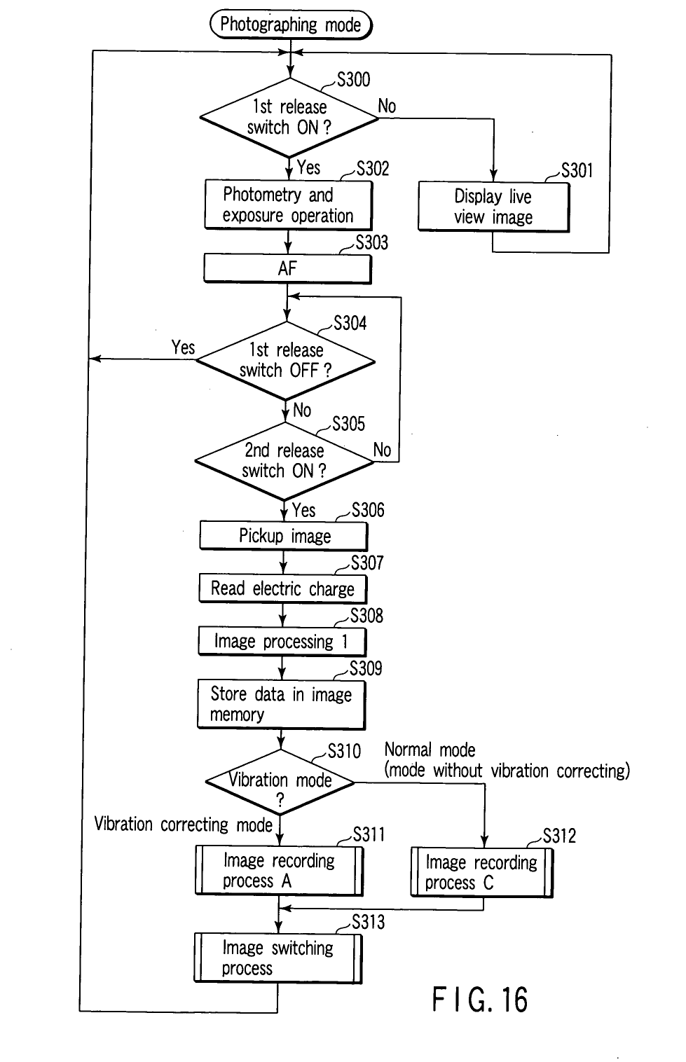

An example including an image switching process in a photographing mode will be described hereinafter in a third embodiment. FIG. 16 shows a main flowchart in the photographing mode of the third embodiment. First, when a power switch 11 is pressed, a lens having a depressed state is set up. Moreover, it is judged whether or not a first release switch of a release switch 3 has been turned on (S300). An image pickup element (CCD) 114 continuously operates in a predetermined period until the first release switch is turned on, and the resultant image data (live view image) is displayed in an electronic view finder 6 and a back-surface LCD panel 10 (S301). When the first release switch of the release switch 3 is turned on, photometry is performed by a photometry sensor (not shown), and a photometry and exposure operation is performed based on the photometry result (S302). Furthermore, a distance measuring sensor (not shown) performs distance measuring, and a focus motor 105 is driven and controlled based on the distance measuring result. Accordingly, a focusing lens 14 is driven to perform automatic focusing (AF) (S303).

Next, it is judged whether or not the first release switch of the release switch 3 has been turned off (S304). When a first release operation is discontinued to stop a image pickup operation, the processing returns to S300 to wait until the first release switch turns on next. If the first release switch is turned on, it is next judged whether or not a second release switch of the release switch 3 has been turned on (S305). Unless the second release switch is turned on, the processing returns to S304 to judge whether or not the first release switch has been turned off. If the second release switch of the release switch 3 is turned on in S305, the image pickup element (CCD) 114 is operated to perform the image pickup. That is, an exposure operation (image pickup) is performed (S306), an electric charge accumulated in the image pickup element (CCD) 114 is photoelectrically converted. Thereafter, image data is read via a CCD output processing circuit 115 (S307). Moreover, an image processing 1 circuit 117-1 performs image processing 1 such as a YC separation process, distortion correction, and shading correction (S308). Moreover, the image data (DTR) subjected to the image processing 1 is stored in an image memory 116 (S309).

Next, a vibration mode is judged (S310). When vibration correction is required (in a vibration correction mode), an image recording process A is performed with respect to the image data (DTR) subjected to the image processing 1 and stored in the image memory 116 (S311). An image recording process C is performed in a normal mode in which any image restoration process is not required either during or after the image pickup (S312). Moreover, the data is subjected to an image switching process in S313 through the image recording processes A, C, and a image pickup sequence for one frame is completed, thereby returning to S300.

Here since the image recording processes A, C are common to those of FIGS. 6, 8 described in the first embodiment, the description is omitted.

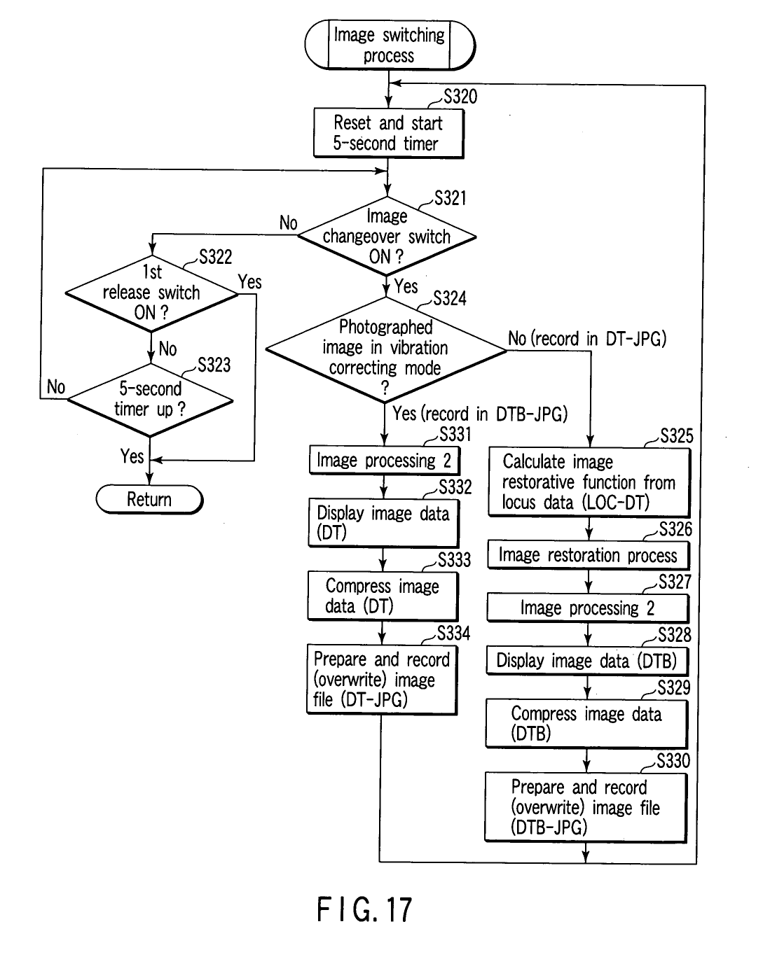

FIG. 17 is a flowchart of an image switching process. First, after a five-second timer is reset and started (S320), it is judged whether or not an image changeover switch has been turned on (S321). When the image changeover switch is off, it is judged whether or not the first release switch has been turned on (S322). Unless the first release switch is pressed, it is judged whether or not the five-second timer has been up (S323). When the five-second timer is up, the processing returns to the photographing mode. Unless the five-second timer is up, the processing returns to S321 to wait until the image changeover switch is turned on. Even if the first release switch is pressed in S322, the processing returns to the photographing mode.

When the image changeover switch is on in S321, it is judged whether or not the image data recorded in an image recording medium 132 is image data photographed in a vibration correcting mode (S324). If the image data is recorded as image data (DTB-JPG) in a data portion of an image file of the image recording medium 132 (image data is photographed in the vibration correcting mode), the image data stored in the image memory 116 is read, and image processing 2 (γ-conversion) is executed (S331). Moreover, the image data (DT) subjected to the image processing 2 is displayed (S332). Next, the image data (DT) is compressed in a compression format conforming to the JPEG by an image compression and de-compression circuit 130 (S333). Thereafter, the compressed image data (DT-JPG) is recorded (overwritten) as an image file (F-DT-JPG) in the image recording medium 132 (S334). Accordingly, an image switching process is completed, and the processing returns to S320 and is on standby.

When the image data is recorded as image data (DT-JPG) in S324 (image data is not photographed in the vibration correcting mode), an image restorative function is calculated based on locus data (LOC-DT) stored in a locus memory circuit 113 by an image restorative function calculating circuit 122 (S325). Moreover, an image restoring process is executed based on the calculated image restorative function by an image restoring operation circuit 123 (S326). Furthermore, the image data stored in the image memory 116 is read, and image processing 2 (γ-conversion) is executed (S327). Moreover, image data (DTB) subjected to the image processing 2 is displayed (S328). Moreover, the image data (DTB) is compressed in the compression format conforming to the JPEG by the image compression and de-compression circuit 130 (S329). The compressed image data (DTB-JPG) is recorded (overwritten) as an image file (F-DTB-JPG) in the image recording medium 132 (S330), an image switching process is completed, and the processing returns to S320 and is on standby.

As described above, in the image switching process in the third embodiment, when the image data recorded in the image recording medium 132 is image data (DTB-JPG) photographed in the vibration correcting mode, the data can be switched to the image data (DT-JPG) that is not photographed in the vibration correcting mode, and the data can be recorded (overwritten). When the image data (DT-JPG) is not photographed in the vibration correcting mode, the data can be switched to the image data (DTB-JPG) photographed in the vibration correcting mode, and the data can be recorded (overwritten). Therefore, the image data different from the photographed image data can be recorded again immediately after the image pickup, and even the image data that is not subjected to the image restoration process during the image pickup can be changed to the image data subjected to the image restoration process, and overwritten.

### Fourth Embodiment

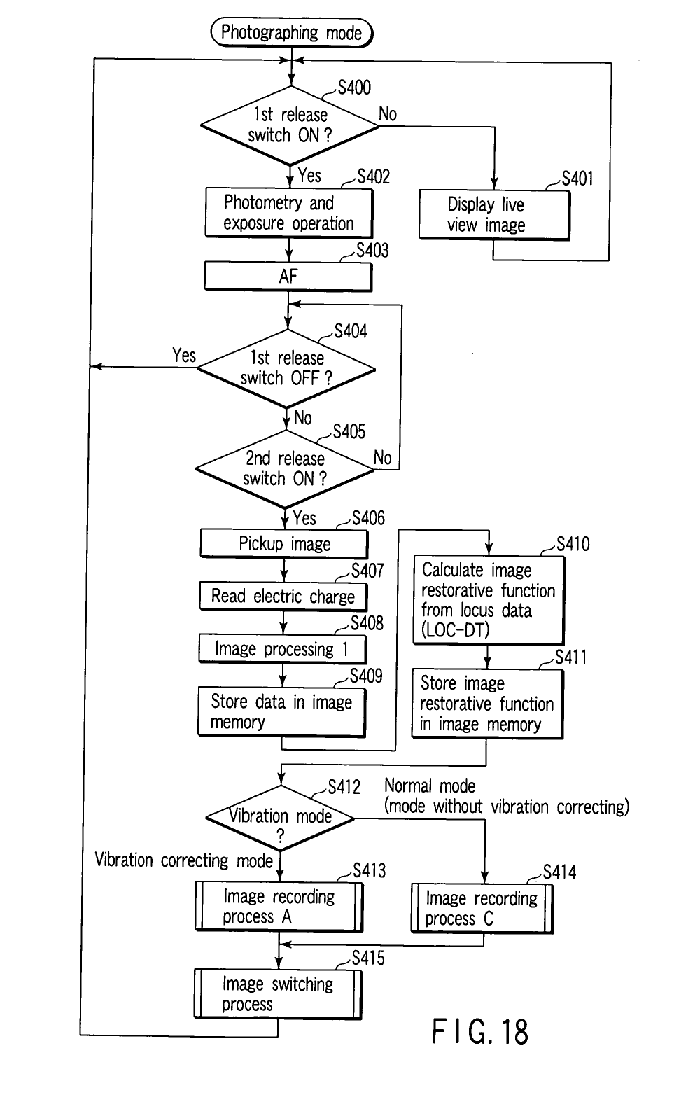

An example will be described hereinafter as a fourth embodiment in which an image switching process is included in a photographing mode, and an image restorative function is stored. FIG. 18 shows a main flowchart of the photographing mode in the fourth embodiment. Steps S400 to S409 and S412 to S415 of FIG. 18 correspond to the steps S300 to S313 in the third embodiment.

When a power switch 11 is pressed, a lens having a depressed state is set up. Moreover, it is judged whether or not a first release switch of a release switch 3 has been turned on (S400). An image pickup element (CCD) 114 continuously operates in a predetermined period until the first release switch is turned on, and the resultant image data (live view image) is displayed in an electronic view finder 6 and a back-surface LCD panel 10 (S401). When the first release switch of the release switch 3 is turned on, photometry is performed by a photometry sensor (not shown), and a photometry and exposure operation is performed based on the photometry result (S402). Furthermore, a distance measuring sensor (not shown) performs distance measuring, and a focus motor 105 is driven and controlled based on the distance measuring result. Accordingly, a focusing lens 14 is driven to perform automatic focusing (AF) (S403).

Next, it is judged whether or not the first release switch of the release switch 3 has been turned off (S404). When a first release operation is discontinued to stop a image pickup operation, the processing returns to S400 to wait until the first release switch turns on next. If the first release switch is turned on, it is next judged whether or not a second release switch of the release switch 3 has been turned on (S405). Unless the second release switch is turned on, the processing returns to S404 to judge whether or not the first release switch has been turned off. If the second release switch of the release switch 3 is turned on in S405, the image pickup element (CCD) 114 is operated to perform the image pickup. That is, an exposure operation (image pickup) is performed (S406), an electric charge accumulated in the CCD 114 is photoelectrically converted. Thereafter, image data is read via a CCD output processing circuit 115 (S407). Moreover, an image processing 1 circuit 117-1 performs image processing 1 such as a YC separation process, distortion correction, and shading correction (S408). Moreover, the image data (DTR) subjected to the image processing 1 is stored in an image memory 116 (S409).

Angular velocity sensors 108, 109 as vibration detecting units constantly operate, and locus data (LOC-DT) by vibration in a period in which this exposure operation (image pickup) is executed is stored in a locus memory circuit 113. When the image data (DTR) subjected to the image processing 1 is stored in an image memory 116, an image restorative function calculating circuit 122 calculates an image restorative function based on the locus data (LOC-DT) stored in the locus memory circuit 113 (S410). Moreover, the calculated image restorative function is stored in the image memory 116 (S411).

Moreover, a vibration mode is judged (S412). When vibration correction is required in this mode (vibration correction mode), an image recording process A is performed with respect to the image data (DTR) subjected to the image processing 1 and stored in the image memory 116 (S413). An image recording process C is performed in a mode (normal mode) in which any image restoration process is not required either during or after the image pickup (S414). Moreover, the data is subjected to an image switching process (S415) through the image recording processes A, C, and a image pickup sequence for one frame is completed, thereby returning to S400.

Here, the image recording process C is common to that of FIG. 8 in the first embodiment. The image switching process is common to that of FIG. 17 in the third embodiment. Therefore, descriptions of the image recording process C and the image switching process are omitted.

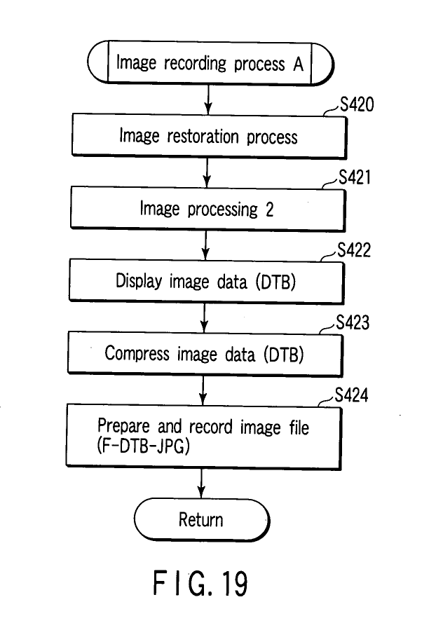

FIG. 19 shows a flowchart of the image recording process A which is a sub-routine. In the fourth embodiment, the image restorative function is calculated by the image restorative function calculating circuit 122, and stored in the image memory 116. Therefore, the image recording process is instantly performed on the image data (DTR) subjected to the image processing 1 and stored in the image memory 116 based on the image restorative function stored in the image memory 116 (S420). The image data subjected to the image restoration process is γ-converted (image processing 2) in an image processing 2 circuit 117-2 (S421). Moreover, the image data (DTB) subjected to the image processing 2 is displayed in LCDs 6, 10 (S422).

The image data (DTB) is compressed in a compression format conforming to the JPEG in an image compression and de-compression circuit 130 (S423). Moreover, the compressed image data (DTB-JPG) is combined with the locus data (LOC-DT) to prepare an image file (F-DTB-JPG), and the file is recorded in an image recording medium 132 (S424). The compressed image data is recorded in a data portion of the image file, and the locus data (LOC-DT) is recorded in a header portion. In the image recording process A, the image file is an image file (F-DTB-JPG) subjected to the image restoration process. Therefore, a B-flag in the header portion of the image file is recorded as 1 (subjected to the image restoration process).

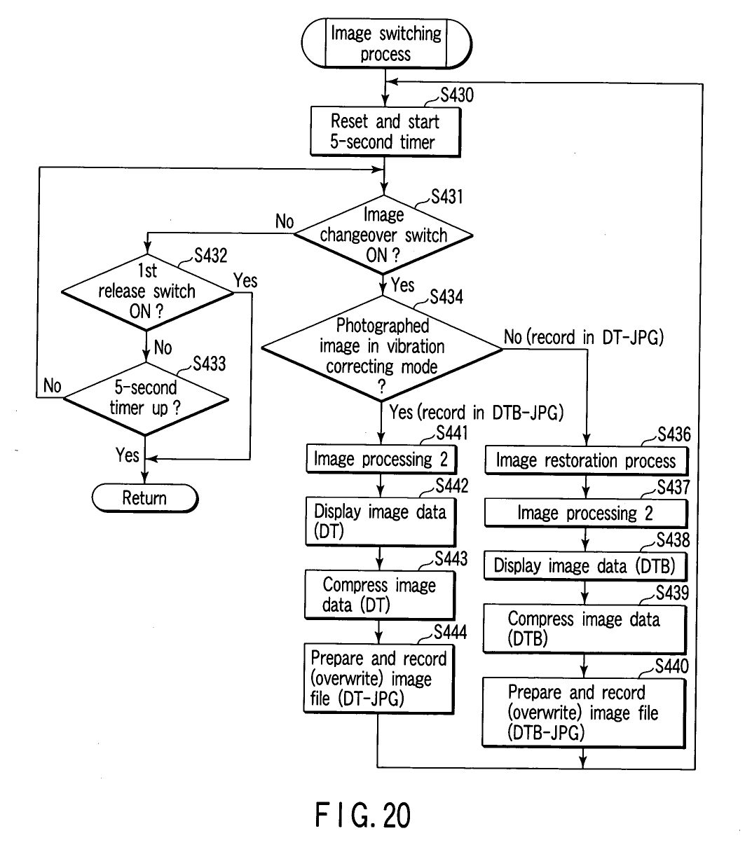

FIG. 20 shows a flowchart of an image switching process. In the fourth embodiment, the image restorative function is calculated by the image restorative function calculating circuit 122, and stored in the image memory 116. Therefore, the fourth embodiment does not require a step of calculating the image restorative function from the locus data (LOC-DT), and a step (S425) corresponding to S325 of FIG. 17 in the third embodiment is omitted in the fourth embodiment.

That is, after a five-second timer is reset and started (S430), it is judged whether or not an image changeover switch has been turned on (S431). When the image changeover switch is off, it is judged whether or not the first release switch has been turned on (S432). Unless the first release switch is pressed, it is judged whether or not the five-second timer has been up (S433). When the five-second timer is up, the processing returns to the photographing mode. Unless the five-second timer is up, the processing returns to S431. Even when the first release switch is pressed in S432, the processing returns to the photographing mode.

When the image changeover switch is on in S431, it is judged whether or not the image data recorded subjected to the image processing 1 and recorded in the image recording medium 132 is image data photographed in a vibration correcting mode (S434). If the image data is recorded as image data (DTB-JPG) in the data portion of the image file of the image recording medium 132 (image data is photographed in the vibration correcting mode), the image data (DTR) stored in the image memory 116 is read, and image processing 2 (γ-conversion) is executed (S441). Moreover, the image data (DT) subjected to the image processing 2 is displayed (S442). Next, the image data (DT) is compressed in a compression format conforming to the JPEG by the image compression and de-compression circuit 130 (S443). Thereafter, the compressed image data (DT-JPG) is recorded (overwritten) as an image file (F-DT-JPG) in the image recording medium 132 (S444), the image switching process is completed, and the processing returns to S430 and is on standby.

When the image data is recorded as image data (DT-JPG) in S434 (image data is not photographed in the vibration correcting mode), an image restoring process is executed based on the image restorative function stored in the image memory 116 by the image restoring operation circuit 123 (S436). Furthermore, the image data (DTB) subjected to the image restoration process is subjected to image processing 2 (γ-conversion) (S437), and the image data (DTB) subjected to the image processing 2 is displayed (S438). Moreover, the image data (DTB) is compressed in the compression format conforming to the JPEG by the image compression and de-compression circuit 130 (S439). The compressed image data (DTB-JPG) is recorded (overwritten) as an image file (F-DTB-JPG) in the image recording medium 132 (S440), the image switching process is completed, and the processing returns to S430 and is on standby.

Even in the fourth embodiment, in the same manner as in the third embodiment, in the image switching process, when the image data recorded in the image recording medium 132 is the image data (DTB-JPG) photographed in the vibration correcting mode, the data is switched to the image data (DT-JPG) that is not photographed in the vibration correcting mode. When the image data is the image data (DT-JPG) that is not photographed in the vibration correcting mode, the data is switched to the image data (DTB-JPG) photographed in the vibration correcting mode. The respective data can be recorded (overwritten). Therefore, the image data different from the photographed image data can be recorded again immediately after the image pickup, and even the image data that is not subjected to the image restoration process during the image pickup can be changed to the image data subjected to the image restoration process, and overwritten.

Here, in the above first to fourth embodiments, when first and second recording modes can be selected, and the first recording mode (image restoring information recording mode; image recording process B) is selected, the image data (DT) that is not subjected to the image restoration process is recorded together with the locus data (LOC-DT) of the vibration detecting signal of the time series or image restoring information such as the image restorative function. When the second recording mode (vibration correcting mode; image recording process A) is selected, the image data (DTB) subjected to the image restoration process is recorded. Therefore, when the first recording mode is selected during the image pickup, the image data (DT) that is not subjected to the image restoration process in postprocessing after the image pickup can be subjected to the image restoration process based on recorded image pickup information, and the image recording process requiring much time can be omitted during the image pickup.

Moreover, when the second recording mode is selected, and the image data subjected to the image restoration process is recorded during the image pickup, the image data subjected to the image restoration process is reproduced with a simple operation, and the image data subjected to the image restoration process can be quickly and easily viewed.

Furthermore, when the image data (DT) that is not subjected to the image restoration process is recorded, and it is possible to select a third recording mode (normal mode) in which any image restoring information is not recorded, it is possible to select the photographing mode that does not require any image restoration process. Accordingly, since any process on image restoration is not required in this photographing mode (third recording mode), power consumption is reduced. Moreover, an operation time is shortened, and continuous image pickup can be performed with little waiting time.

### Fifth Embodiment

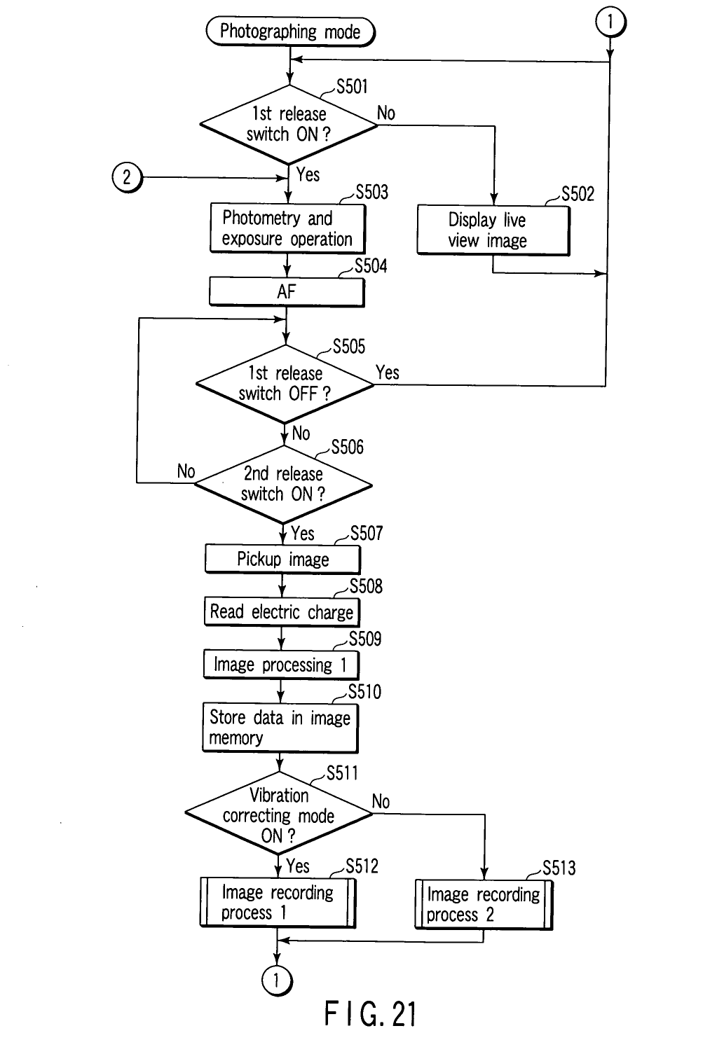

FIG. 21 shows a main flowchart of a photographing mode in a fifth embodiment. First, when a power switch 11 is pressed, a lens having a depressed state is set up. Moreover, it is judged whether or not a first release switch of a release switch 3 has been turned on (S501). An image pickup element (CCD) 114 continuously operates in a predetermined period until the first release switch is turned on, and the resultant image data (live view image) is displayed in an electronic view finder 6 and a back-surface LCD panel 10 (S502). When the first release switch of the release switch 3 is turned on, photometry is performed by a photometry sensor (not shown), and a photometry and exposure operation is performed based on the photometry result (S503). Furthermore, a distance measuring sensor (not shown) performs distance measuring, and a focus motor 105 is driven and controlled based on the distance measuring result. Accordingly, a focusing lens 14 is driven to perform automatic focusing (AF) (S504).

Subsequently, it is judged whether or not the first release switch of the release switch 3 has been turned off (S505). When a first release operation is discontinued to stop a image pickup operation, the processing returns to S501 to wait until the first release switch turns on next. If the first release switch is turned on in S505, it is next judged whether or not a second release switch of the release switch 3 has been turned on (S506). Unless the second release switch is turned on, the processing returns to S505 to judge whether or not the first release switch has been turned off. If the second release switch of the release switch 3 is turned on in S506, the image pickup element (CCD) 114 is operated to perform the image pickup. That is, an exposure operation (image pickup) is performed (S507), an electric charge accumulated in the image pickup element (CCD) 114 is photoelectrically converted. Thereafter, image data is read via a CCD output processing circuit 115 (S508). Moreover, an image processing 1 circuit 117-1 performs image processing 1 such as a YC separation process, distortion correction, or shading correction (S509). Moreover, the image data (referred to as DTR) subjected to the image processing 1 is stored in an image memory 116 (S510). Here, although not shown in FIG. 21, angular velocity sensors 108, 109 as vibration detecting units constantly operate, and locus data (LOC-DT) by vibration in a period in which this exposure operation (image pickup) is executed is stored in a locus memory circuit 113.

Next, it is judged whether or not a vibration correction mode is turned on (S511). When a vibration mode switch 5 is turned on to set the vibration correcting mode, an image recording process 1 is performed on the image data (DTR) subjected to the image processing 1 and stored in the image memory 116 (S512). When the vibration correcting mode is off, an image recording process 2 is performed (S513). Moreover, a image pickup sequence for one frame is completed through the image recording processes 1, 2, and the processing returns to S501.

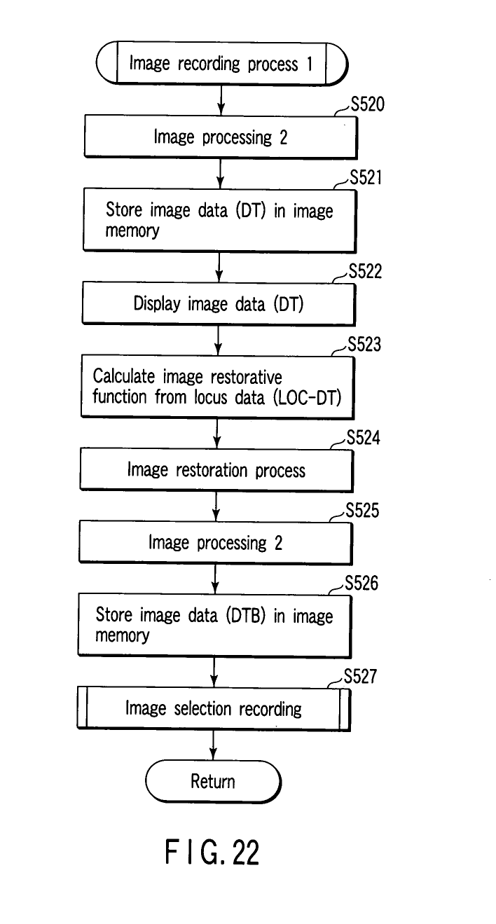

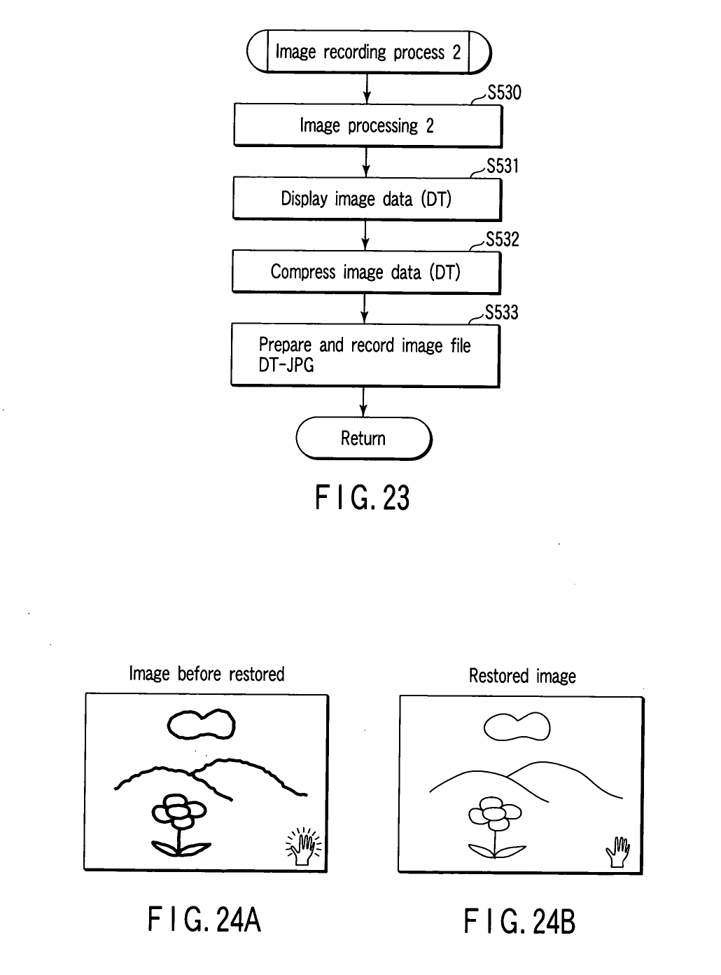

FIGS. 22 and 23 show flowcharts of the image recording processes 1, 2 which are sub-routines. In the flowchart of the image recording process 1 shown in FIG. 22, first the image data (DTR) subjected to the image processing 1 and stored in the image memory 116 is read, the data is subjected to image processing 2 (γ-conversion) (S520), and the data is stored in the image memory 116 (S521). To distinguish the data, the image data subjected to the image processing 2 before the image restoration process is referred to as image data (DT).

The image data (DT) subjected to the image processing 2 is not subjected to any vibration correction, and the image data (DT) before subjected to the image restoration process is displayed for the time being in the LCDs 6, 10 as shown in FIG. 24A (S522). Moreover, an image restorative function is calculated by an image restorative function calculating circuit 122 based on locus data (LOC-DT) stored the locus memory circuit 113 (S523). Moreover, the image data (DTR) stored in the image memory 116 is subjected to the image restoration process based on the calculated image restorative function (S524).

In the display of the image data (DT) before restored in FIG. 24A, “vibration mark” blinks, and it is also displayed that an image restoring operation is being performed. When the “vibration mark” is turned on and off, and it is also displayed that the image restoring operation is being performed, a user of a digital camera can be notified that the presently displayed image data is image data before restored.

Next, image processing 2 is executed with respect to the restored image data (S525). To distinguish the resultant image data (image data after the image restoration process), the data is referred to as image data (DTB). Moreover, the restored image data (DTB) is stored in the image memory 116. Thereafter, an image is selected, and recorded in an image recording medium 132 (S527). The selective recording of the image will be described later.

Here, since the image data (DT) before the image restoration process and the image data (DTB) after the image restoration process are stored in the image memory 116, they can be displayed in parallel. Moreover, the images to be displayed in the LCDs 6, 10 may be switched from the image data (DT) before the image restoration process to the image data (DTB) after the image restoration process by the image changeover switch, thereby displaying the image data (DTB) after the image restoration process as shown in FIG. 24B.

Next, a flowchart of the image recording process 2 will be described with reference to FIG. 23. In the image recording process 2, any vibration correction is not executed. First, the image data stored in the image memory 116 is read, and subjected to the image processing 2 (γ-conversion) (S530). Next, the image data (DT) before the image restoration process are displayed in the LCDs 6, 10 (S531). The image data (DT) is compressed in a compression format conforming to the JPEG in an image compression and de-compression circuit 130 (S532). Next, the compressed image data (DT-JPG) and the locus data (LOC-DT) are combined to prepare an image file, and the file is stored in the image recording medium 132 (S533).

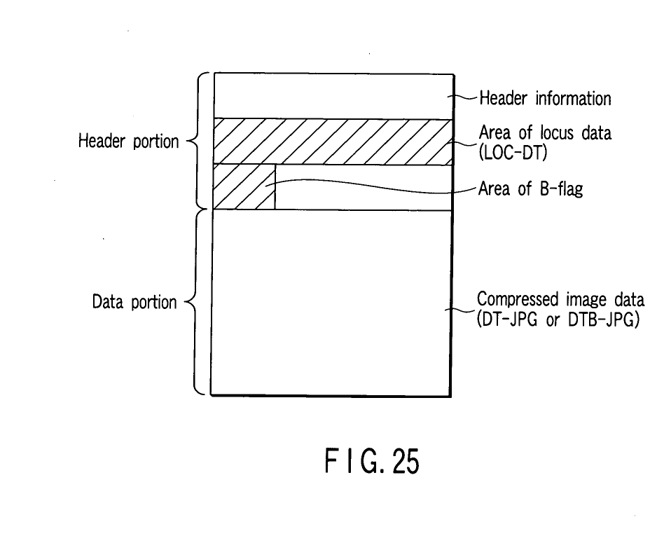

FIG. 25 shows a structure of the image file. The image file includes: a data portion in which the compressed image data (DTB-JPG) is recorded; and a header portion in which there are recorded the locus data (LOC-DT), header information (image pickup parameter, standard information of image data, etc.) accompanying the image file, and a B-flag indicating whether or not the image file has been subjected to the image restoration process.

Moreover, the compressed image data is recorded in the data portion of the image file, and the locus data (LOC-DT) is recorded in the header portion. When the image file (DT) is not subjected to the image restoration process in the image recording process 2, the B-flag of the header portion of the image file is recorded as 0 (without any image restoration process).

During the image pickup in the vibration correcting mode, while the image restoring operation requiring much time is performed, the image data (DT) before restored is displayed as shown in FIG. 24A. Therefore, a structural outline or a shutter timing is quickly confirmed.

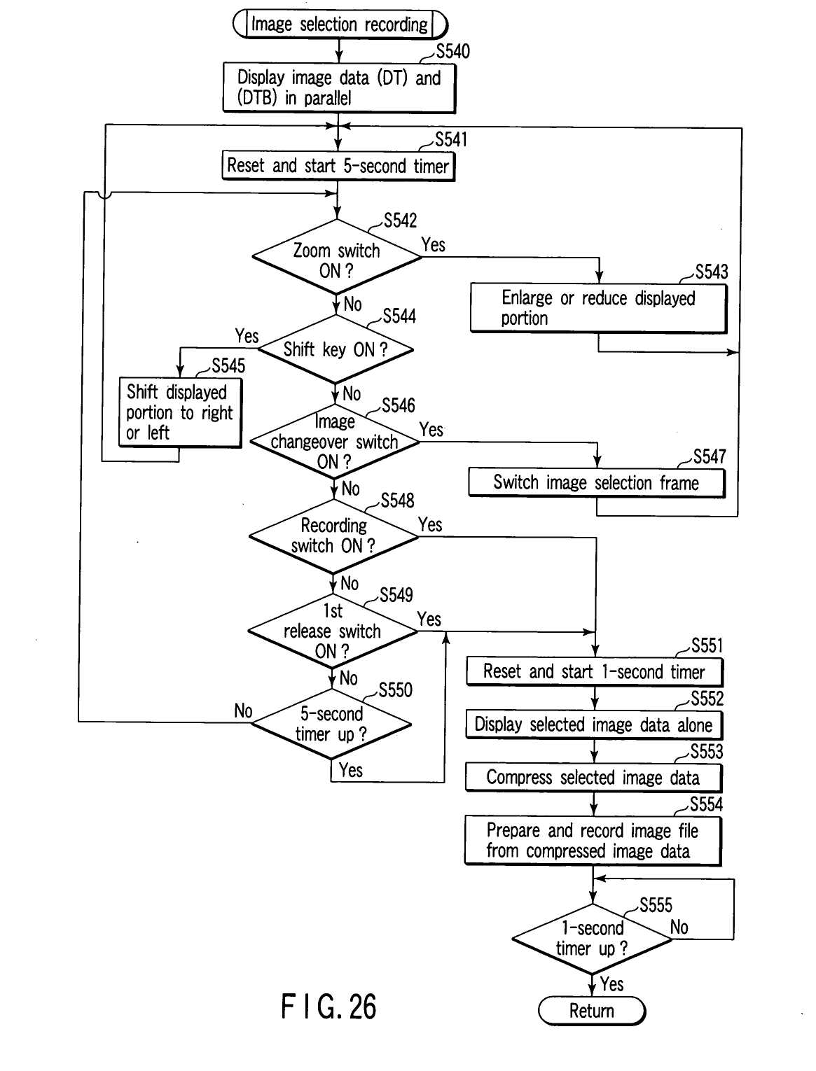

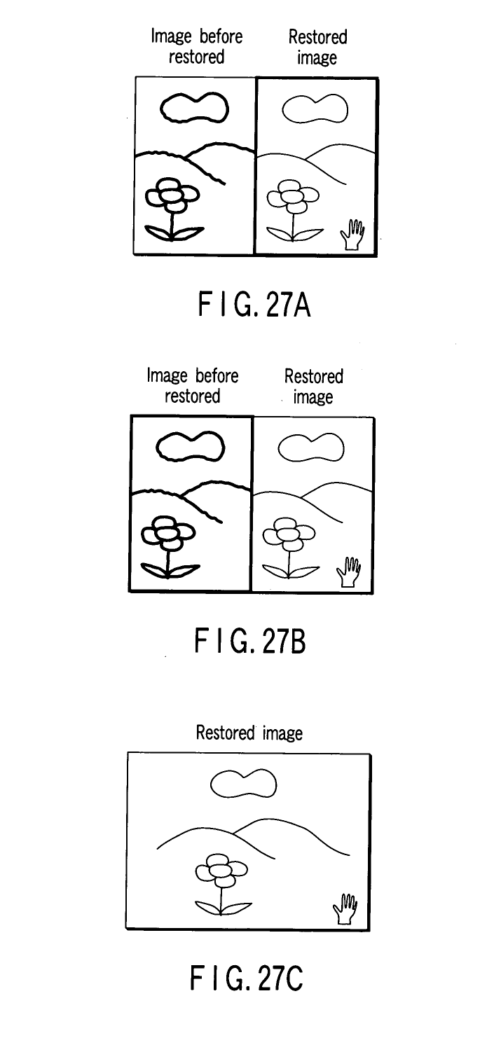

FIG. 26 shows a flowchart of the image selection recording of FIG. 22. First, the image data (DT) before the image restoration process stored in the image memory 116 and the image data (DTB) after the image restoration process are read, they are displayed in parallel in divided right and left screens as shown in FIG. 27A (S540). A parallel display time is, for example, five seconds. In this case, a five-second timer is reset and started (S541).

In the parallel display, there is displayed the same area of a predetermined part of the whole area of each of the image data (DT) before the image restoration process and the image data (DTB) after the image restoration process. Since the same area of the predetermined part is displayed side by side, the image data before the image restoration can be compared directly with that after the image restoration. Consequently, an effect of image restoration can be visually confirmed, and effective confirmation is possible.

In general, a main subject exists in the center. Therefore, when the center of the whole area of the image data is displayed as the same area of the predetermined part, an area having a high probability that the main subject exists is automatically displayed. Accordingly, the effect of the image restoration process can be efficiently confirmed.

In the display of the image data (DTB) after the image restoration process, a mark of a hand that does not blink is also displayed. Accordingly, it is notified that the image data being displayed is the image data (DTB) after the image restoration.

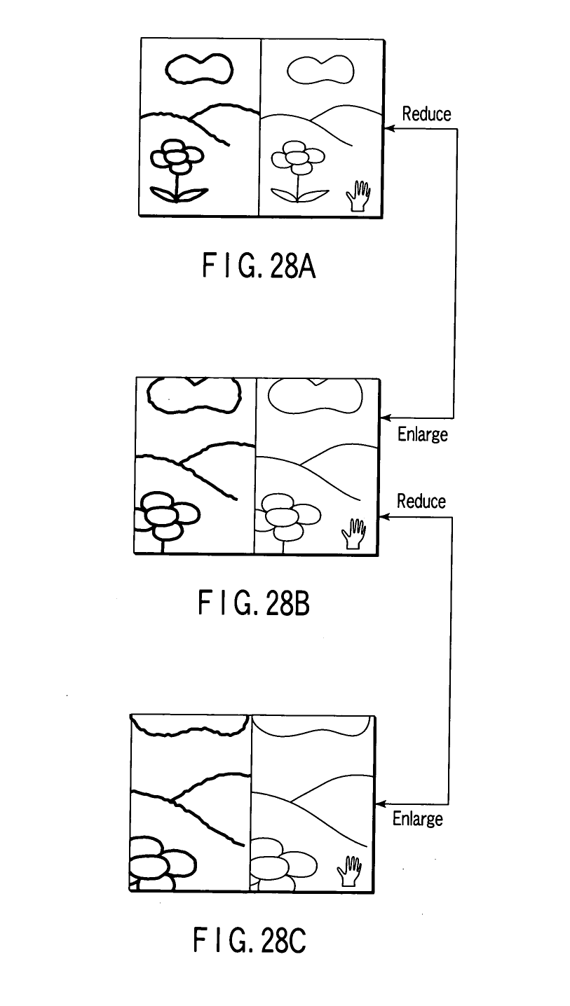

After the five-second timer is reset and started, it is judged whether or not a zoom switch 4 has been turned on (S542). When the zoom switch 4 is turned on, and this zoom switch 4 is a T-button 4-1, the displays in the LCDs 6, 10 (view finder 6, back-surface LCD panel 10) are enlarged. When a W-button 4-2 is turned on, the display is reduced. FIGS. 28A to 28C show enlargement and reduction of displayed images in the LCDs 6, 10. The image data is enlarged and displayed as in FIG. 28A→FIG. 28B→FIG. 28C, or reduced and displayed as in FIG. 28C→FIG. 28B→FIG. 28A. When the displayed images are enlarged or reduced, the processing returns to S541 to reset and start the five-second timer. Thereafter, the processing is started with respect to the enlarged or reduced image data as an object.

Not the whole area but the predetermined part of the image data is displayed. Therefore, the displayed area can be enlarged or reduced. Furthermore, since the same area of the predetermined part is displayed, both of the image data (DT) before the image restoration process and the image data (DTB) after the image restoration process can be compared with each other in the display having an appropriately enlarged or reduced size. In consequence, an effect of image restoration can be confirmed in detail.

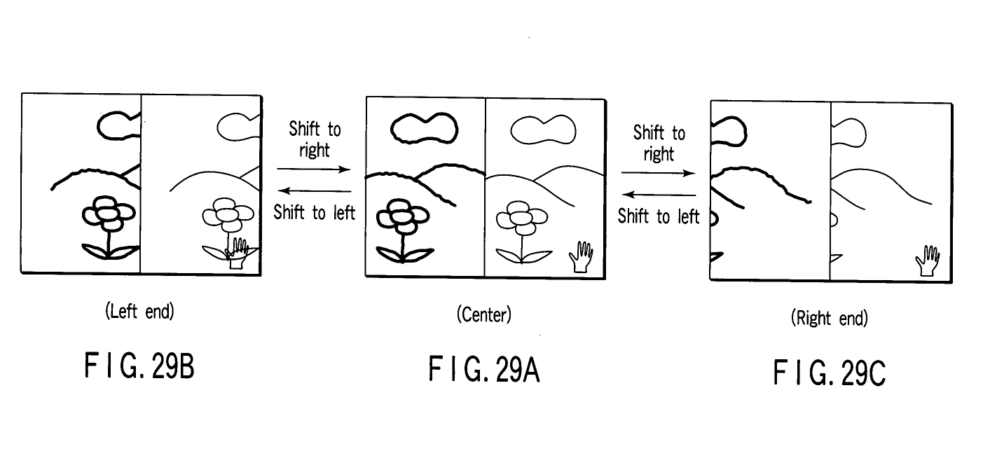

When the zoom switch 4 is off in S542, it is next judged that the shift key has been turned on (S544). When the shift key is turned on, and this shift key is a left shift key, the displayed image is shifted to the left. When the shift key that has been turned on is a right shift key, the displayed image is shifted to the right (S545). FIGS. 29A to 29C show the shifts of the displayed image. The images displayed in the central portions of the LCDs 6, 10 are shifted to the left by the left shift key as shown in FIGS. 29A and 29B. Alternatively, each image is shifted to the right by the right shift key as shown in FIGS. 29A and 29C. When the displayed image is shifted to the left or right, the processing returns to S541 to reset the five-second timer, and the processing is started with respect to the image data shifted to the left or right as an object.

The displayed image data is not the whole area but is the predetermined part. Therefore, the displayed area shifts to the left or the right, and a desired area can be selectively displayed. Therefore, even if the main subject does not exist in the central portion of the whole area, the area in which the main subject exists is selectively displayed. Therefore, even the main subject existing in any area can be handled, and an image restoration effect can be confirmed from a photographed state of a main subject in the selectively displayed area.

When the shift key is off in S544, it is judged whether or not the image changeover switch has been turned on (S546). When the image changeover switch is on, an image selection frame is switched. Thereafter, the processing returns to S541 to reset the five-second timer, and processing is started with respect to the selected image data as an object.

Here, when the image changeover switch is on, the image (DT) before the image restoration process and the image (DTB) after the image restoration process are alternately selected by pressing the image changeover switch. Moreover, in the image (DT) before the image restoration and the image (DTB) after the image restoration which are displayed in parallel, in FIG. 27A, a frame of the image (DTB) before the image restoration is selected. In FIG. 27B, a frame of the image (DT) before the image restoration is selected.

When the image changeover switch is off in S546, it is judged that the image data to be restored is selected, and it is judged whether or not the recording switch has been turned on (S548). If the recording switch is not pressed (turned off), it is judged whether or not the first release switch has been turned on (S549). When the first release switch is off, it is judged whether or not the five-second timer has been up (S550). When the first release switch is off, any of the zoom switch, the shift key, the image changeover switch, and the recording switch remains to be off for five seconds, and the five-second timer is up, it is judged that an image provided with a selection frame has been selected as an image to be recorded. In this case, a one-second timer to display the image for one second only is reset and started (S551). Unless five seconds do not elapse, the processing returns to S542 to judge whether or not the zoom switch has been turned on. In a case where the recording switch is on in S548, or the first release switch is on in S549, it is judged that the image data to be restored has been selected, and the processing shifts to S551 without waiting until the five-second timer times up. Moreover, the one-second timer is reset and started.

When the one-second timer is reset and started, the parallel display changes to single display of the selected image data. FIG. 27C shows one example of the single display. In a case where the frame of the restored image (DTB) shown in FIG. 27A is selected, when the recording switch or the first release switch is pressed, or five seconds have passed without pressing the recording switch or the first release switch, as shown in FIG. 27C, the restored image (DTB) is displayed (single whole-area display) alone for one second only by use of the whole areas of the LCDs 6, 10. The singly displayed image (DTB) is compressed in the compression format conforming to the JPEG by the image compression and de-compression circuit 130 (S553). Moreover, the compressed image data (DT-JPG) and the locus data (LOC-DT) are combined to prepare an image file, and the file is recorded in the image recording medium 132 (S554).

The compressed image data (DTB-JPG) is stored in a data portion of the image file, and there are recorded in a header portion of the image file: locus data (LOC-DT); header information (image pickup parameter, standard information of image data, etc.) accompanying the image file; and a B-flag which is a flag indicating the presence of the image restoration process. When the image file is an image file (F-DTB-JPG) subjected to the image restoration process, B-flag is 1. With the image file (DT-JPG) which is not subjected to the image restoration process, the B-flag is 0.

When a single display time of one second elapses, and the one-second timer times up, the processing returns to a main flowchart of the photographing mode. A live view image is displayed, and the processing is on standby until the first release switch turns on.

While performing the image restoration process requiring much time, the image data (DT) which is not subjected to the image restoration is displayed (see FIG. 24A), so that a structural outline or a shutter timing can be quickly confirmed. Moreover, after the image restoration process, the single display of the image data (DT) which is not subjected to the image restoration is switched to parallel display (see FIGS. 27A, 27B) of both of the image data (DTB) subjected to the image restoration process and the image data (DT) which is not subjected to the image restoration process, and both of them are displayed. Therefore, both of the image data can be easily compared with each other by the parallel display, and an effect of the image restoration process can be effectively confirmed.

Moreover, after the display is switched to the parallel display of both of the image data (DTB) subjected to the image restoration process and the image data (DT) which is not subjected to the image restoration process, one of the image data is selected, and the display is switched to the single display (FIG. 27C) of the selected image data (DT or DTB). In this case, the user can become settled to confirm the selected image data (DT or DTB) only in detail.

### Sixth Embodiment

In the fifth embodiment, image data (DT) which is not subjected to image restoration is displayed alone during an image restoration process. Moreover, after the image restoration process, display is switched to parallel display of both of image data (DTB) subjected to the image restoration process and the image data (DT) which is not subjected to the image restoration process. Furthermore, one of both of the image data displayed in parallel is selected and recorded. On the other hand, instead of the parallel display, the displays of both of the image data may be switched, and the displayed image data may be recorded as the selected image data. A constitution for this switch display will be described hereinafter as a sixth embodiment.

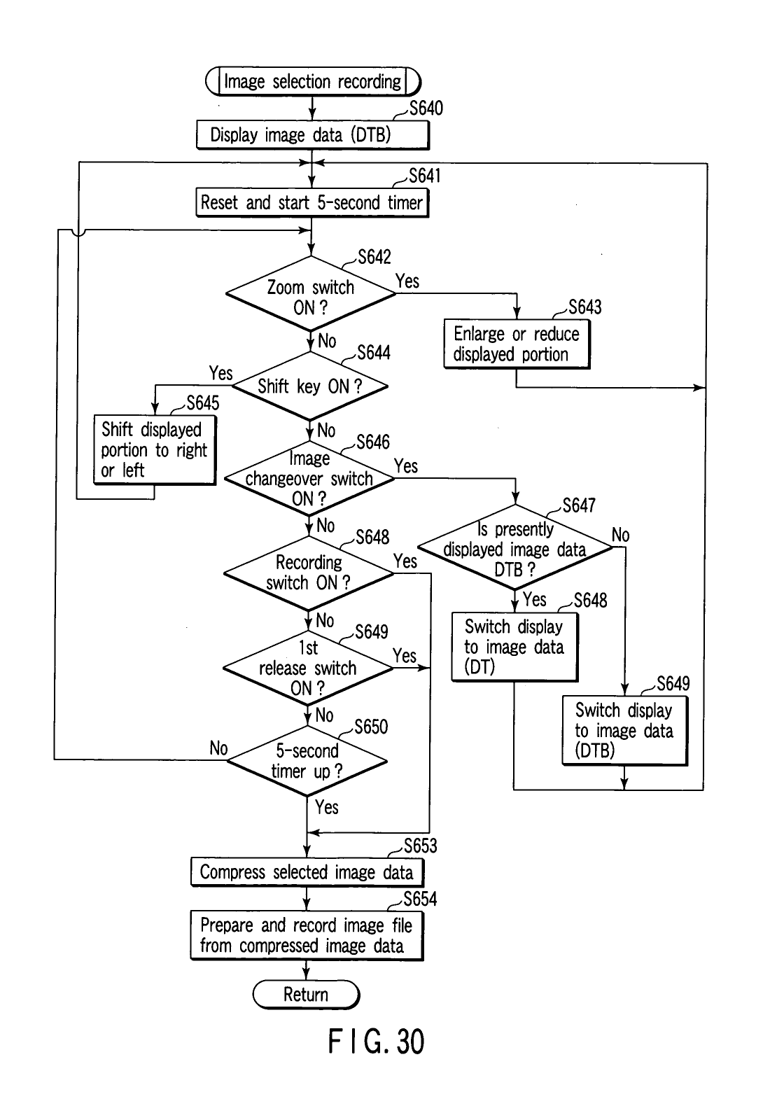

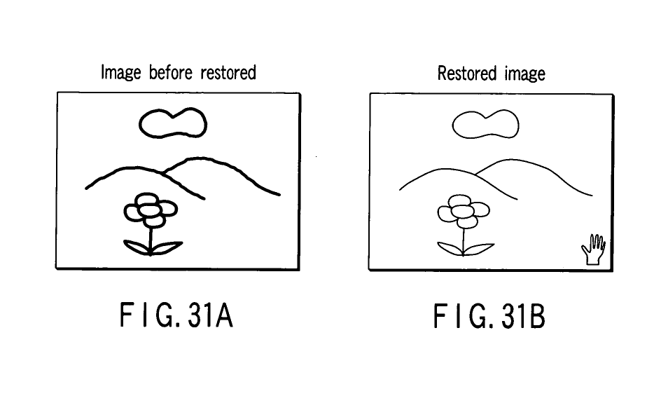

FIG. 30 shows a flowchart of image selection recording in the sixth embodiment. First, image data (DTB) subjected to the image restoration process stored in an image memory 116 is read, and displayed in LCDs 6, 10 (view finder 6, back-surface LCD panel 10) as shown in FIG. 31A (S640). A display time is, for example, five seconds. In this case, a five-second timer is reset and started (S641).

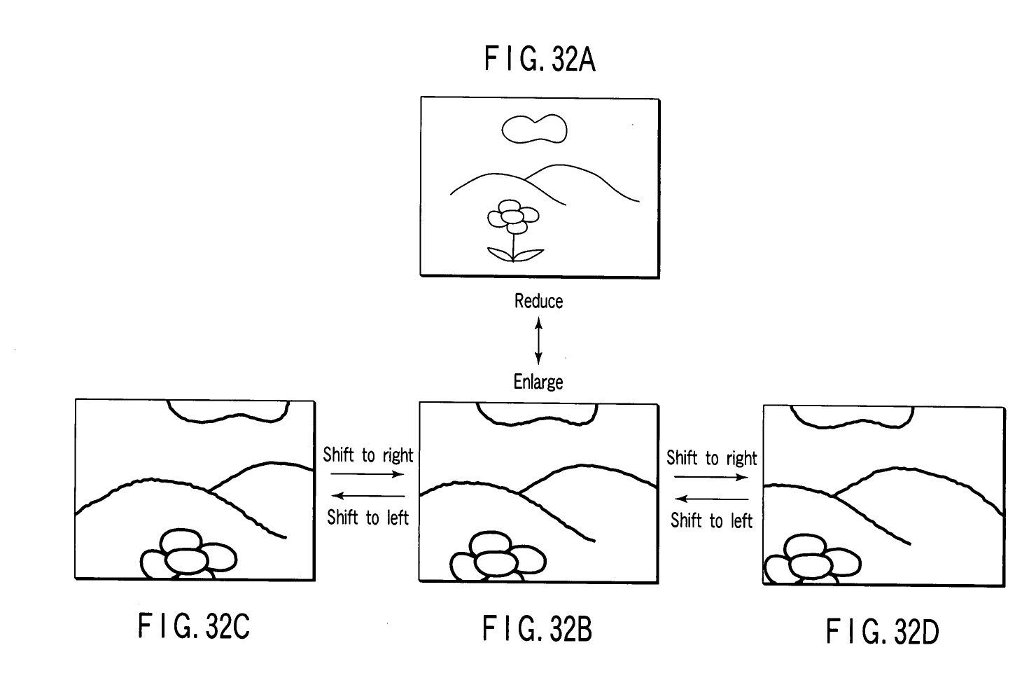

Thereafter, it is judged whether or not a zoom switch 4 has been turned on (S642). When the zoom switch 4 is turned on, and this zoom switch 4 is a T-button 4-1, the displayed images of the LCDs 6, 10 are enlarged. When a W-button 4-2 is turned on, the displayed image is reduced. FIGS. 32A and 32B show enlargement and reduction of a displayed image in the LCDs 6, 10. The image data is enlarged and displayed as in FIG. 32A→FIG. 32B, or reduced and displayed as in FIG. 32B→FIG. 32A. When the zoom switch 4 is turned on, and the displayed images are enlarged or reduced, the processing returns to S641 to reset and start the five-second timer. Thereafter, the processing is started with respect to the enlarged or reduced image data as an object.

When the zoom switch 4 is off in S542, it is next judged that the shift key has been turned on (S644). When the shift key is turned on, and this shift key is a left shift key, the displayed image is shifted to the left. When the shift key that has been turned on is a right shift key, the displayed image is shifted to the right (S645). FIGS. 32B to 32D show the shifts of the displayed image. The image (FIG. 32B) enlarged and displayed in the LCDs 6, 10 is shifted to the left by the left shift key as shown in FIG. 32C. Alternatively, the image is shifted to the right by the right shift key as shown in FIG. 32D. When the displayed image is shifted to the left or right by the shift key, the processing returns to S641 to reset the five-second timer, and the processing is started with respect to the image data shifted to the left or right as an object.

When the shift key is off in S644, it is judged whether or not the image changeover switch has been turned on (S646). When the image changeover switch is on, it is judged whether or not the image data being displayed is an image (DTB) subjected to image restoration (S647). When the image data being displayed is an image (DTB) subjected to the image restoration, the data is switched to the image data (DT) before the image restoration, and the image data (DT) before the image restoration is displayed as shown in FIG. 31A (S648). When the image data being displayed is not the image (DTB) subjected to the image restoration, the data is switched to the image data (DTB) subjected to the image restoration, and the restored image data (DTB) is displayed as shown in FIG. 31B (S649). When the image data being displayed is switched between the image data (DT) before the image restoration and the image data (DTB) after the image restoration, the processing returns to S641 to reset the five-second timer, and the processing is started with respect to the switched image data as an object.

When the image changeover switch is off in S646, it is next judged whether or not a recording switch has been turned on (S650). If the recording switch is not pressed (turned off), it is judged whether or not a first release switch has been turned on (S651). When the first release switch is off, it is judged whether or not the five-second timer has been up (S652). When the first release switch is off, any of the zoom switch, the shift key, the image changeover switch, and the recording switch remains to be off for five seconds, and the five-second timer is up, it is judged that the image data being displayed has been selected as an image data to be recorded. In this case, the data is compressed in a compression format conforming to the JPEG in an image compression and de-compression circuit 130 (S653). Moreover, the compressed image data (DT-JPG or DTB-JPG) is combined with locus data (LOC-DT) to prepare an image file, and the file is recorded in an image recording medium 132 (S654). When the image file is recorded in the image recording medium 132, the processing returns to a main flowchart of a photographing mode, a live view image is displayed until the first release switch turns on, and the processing is on standby.

The compressed image data (DT-JPG or DTB-JPG) is stored in a data portion of the image file, and there are recorded in a header portion of the image file the locus data (LOC-DT), header information (image pickup parameter, standard image of image data, etc.) accompanying the image file, and a B-flag which is a flag indicating presence of an image restoration process. When the image file is an image file (DTB-JPG) subjected to the image restoration process, the B-flag indicates 1. When the image file is not subjected to any image restoration process (DT-JPG), the B-flag indicates 0.

When the recording switch is pressed in S650, or the second release switch is pressed in S651, the processing shifts to S653, and the selected image data is compressed without waiting until the five-second timer is up. If the five-second timer is not up in S652, the processing returns to S642 to judge whether or not the zoom switch has been turned on.

Here, the fifth embodiment is different from the sixth embodiment in the display of the image data. The parallel display is performed in the fifth embodiment whereas the display is switched in the sixth embodiment. Moreover, since another constitution is common to the fifth embodiment, description of the constitution common to the fifth embodiment is omitted.

In the sixth embodiment, both of the images of the image data (DTB) subjected to the image restoration process and the image data (DT) that is not subjected to the image restoration process are switched and displayed. The image data displayed just before can be compared with the presently displayed image data. Accordingly, an effect of the image restoration process can be effectively confirmed.

### Seventh Embodiment

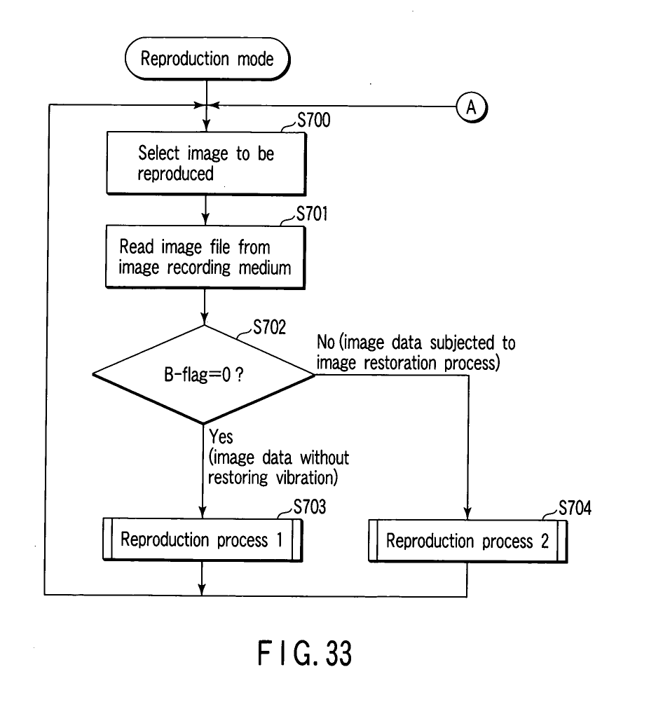

A seventh embodiment characterized in display of a reproduction mode will be described hereinafter. FIG. 33 is a flowchart of the reproduction mode. First, when it is detected in a reproduction screen that a right shift key or a left shift key has been turned on, image data is changed, and image data as an object of the reproduction is selected (S700). Moreover, an image file of the selected image data is read from an image recording medium 132 (S701).

Here, compressed image data (DT-JPG or DTB-JPG) is stored in a data portion of the image file, and there are stored in a header portion of the image file locus data (LOC-DT), header information (image pickup parameter, standard image of image data, etc.) accompanying the image file, and a B-flag which is a flag indicating presence of an image restoration process. When the image file is an image file (DTB-JPG) subjected to the image restoration process, the B-flag indicates 1. When the image file is not subjected to any image restoration process (DT-JPG), the B-flag indicates 0.

It is judged whether or not the image file is image data (DT) which is not subjected to the image restoration process by judging whether or not B-flag=0 (S702). If the B-flag indicates 0, and the image file is compressed image file (DT-JPG) that is not subjected to the image restoration process, the reproduction process is performed by a reproduction process 1 (S703). When the B-flag indicates 1, and the image file is compressed image file (DTB-JPG) subjected to the image restoration process, the reproduction process is performed by a reproduction process 2 (S704). Moreover, when the reproduction processes 1, 2 are completed, the processing returns to S700 to select the next image data as the object of the reproduction.

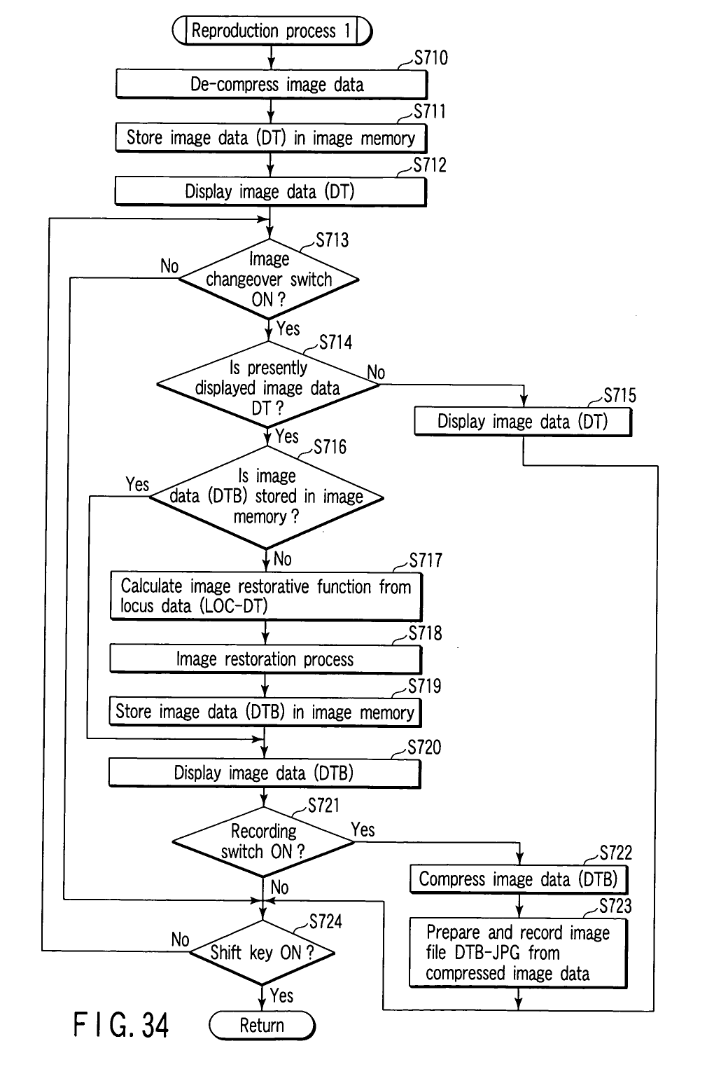

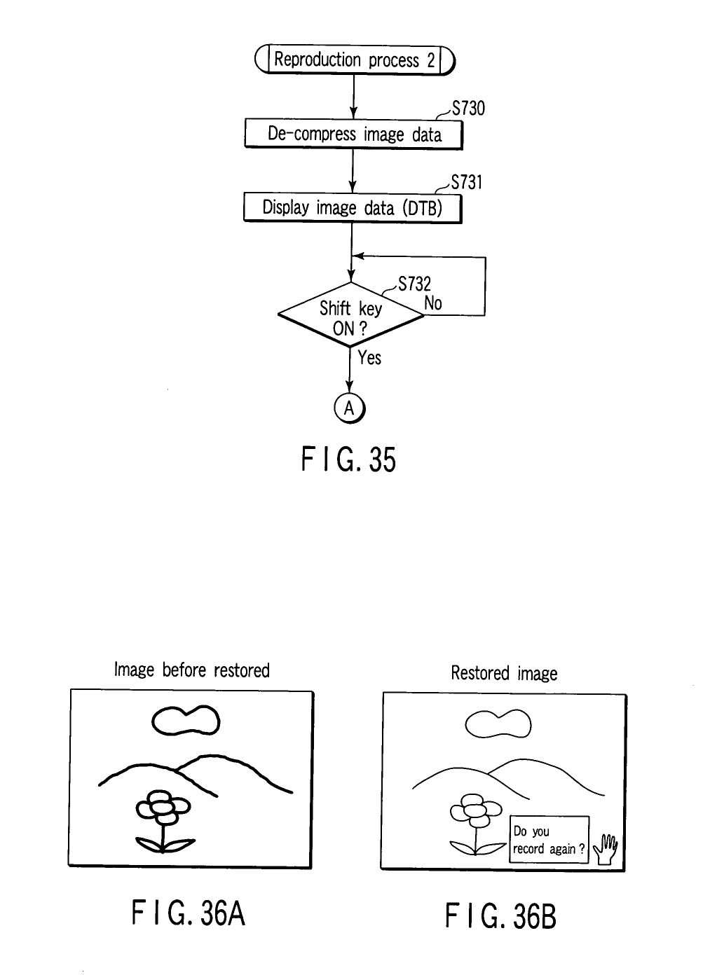

FIGS. 34 and 35 show flowcharts of the reproduction processes 1 and 2 of FIG. 33, respectively. First, the reproduction process 1 will be described with reference to FIG. 34. First, the selected image data is de-compressed in an image compression and de-compression circuit 130 (S710). In the reproduction process 1, the image data before subjected to the image restoration process is an object. Therefore, the de-compressed image data is image data (DT). Therefore, the image data (DT) is stored in an image memory 116 (S711). Thereafter, the image data (DT) is read, and displayed in LCDs 6, 10 (view finder 6, back-surface LCD panel 10) as shown in FIG. 36A (S712).

Next, it is judged whether or not an image changeover switch has been turned on (S713). When the image changeover switch is off, the processing shifts to S724 to judge whether the left shift key or the right shift key has been turned on. When the shift key is pressed, the mode returns to the reproduction mode. When the key is not pressed, the processing returns to S713.

When the image changeover switch is pressed in S713, it is judged whether or not the image data being displayed is image data (DT) (S714). When the data is not the image data (DT), and the data is image data DTB subjected to image restoration, the image data (DT) stored in the image memory 116 in S711 is read and displayed (S715). Next, the processing shifts to S724 to judge whether the shift key has been turned on. When the shift key is pressed, the mode returns to the reproduction mode, and the data changes to the next data. If the key is not pressed, the processing returns to S713 to continue the reproduction process.

When it is judged in S714 that the image data being displayed is the image data (DT) before subjected to the image restoration, it is judged whether or not the corresponding image data (DTB) subjected to the image restoration is stored in the image memory 116 (S716). Unless the image data (DTB) subjected to the image restoration is stored in the image memory 116 in S716, the image needs to be restored. In this case, an image restorative function calculating circuit 122 calculates an image restorative function based on the locus data (LOC-DT) (read from the image recording medium 132 in S701) (S717). Next, the image data (DT) is sent to an image restoring operation circuit 123, and the image restoring operation circuit executes the image restoration process based on the image restorative function calculated by the image restorative function calculating circuit 122 (S718). Moreover, the image data (DTB) subjected to the image restoration process is recorded in the image memory 116 (S719). Thereafter, the display of the image data (DT) is switched to that of the image data (DTB), and the image data (DTB) is displayed in the LCDs 6, 10 as shown in FIG. 36B (S720).

Next, it is judged whether or not a recording switch has been turned on (S721). When the recording switch is turned on for re-recording, the image data (DTB) is compressed in the compression format conforming to the JPEG by the image compression and de-compression circuit 130 (S722). Moreover, the compressed image data (DTB-JPG) is combined with the locus data (LOC-DT) to prepare an image file, and the file is overwritten in the image recording medium 132 (S723). As shown in FIG. 36B, the re-recording is urged in the display of the image data (DTB), and the re-recording can be prevented from being forgotten. When the recording switch is not turned on in S721, it is judged in S724 whether or not the shift key has been turned on without recording the image data (DTB) again. When the shift key is pressed, the mode returns to the reproduction mode. When the key is not pressed, the processing returns to S713 to start the next reproduction process.

In S716, the image data (DTB) is not recorded in the image memory for the first time. On the other hand, for the second time and subsequently, since the image data (DTB) is already recorded, steps S717 to S719 are omitted for the second time and subsequent, the processing shifts to S720, and the display of the image data (DT) is immediately switched to that of the image data (DTB).

Next, the reproduction process 2 will be described with reference to FIG. 35. First, the selected image data is de-compressed in the image compression and de-compression circuit 130 (S730). In the reproduction process 2, since the image data after the image restoration process is an object, the de-compressed image data is the image data (DTB). Therefore, after displaying this image data (DTB) (S731), it is judged that the shift key has been turned on (S732). When the right shift key or the left shift key is pressed, the mode returns to the reproduction mode, and the data shifts to the next image data. When the key is not pressed, the processing waits until the key is pressed.

In this manner, the image data (DT) before the image restoration and the image data (DTB) after the image restoration are alternately displayed in the reproduction mode by the switching of the image changeover switch as shown in FIGS. 36A, 36B. Therefore, since the image data (DT) before the image restoration and the image data (DTB) after the image restoration are switched and displayed, an effect of image restoration can be confirmed at any time after the image pickup.

Here, the reproduction mode of the seventh embodiment is applicable to the fifth and sixth embodiments.

In the seventh embodiment, both of the image data (DT) before the image restoration and the image data (DTB) after the image restoration are switched and displayed as shown in FIGS. 36A, 36B. Instead of such switch display, the parallel display may be performed as shown in FIGS. 27A, 27B. When the parallel display is performed, the image data (DT) before the image restoration can be compared directly with the image data (DTB) after the image restoration. Therefore, an effect of image restoration can be visually confirmed, and effective confirmation is possible.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image pickup apparatus comprising:
an image pickup unit which obtains image data from a subject image formed by an optical system;
a vibration detecting unit which detects a vibration of the image pickup apparatus;
an image restorative function calculating unit which calculates an image restorative function from a vibration detecting signal of a time series output from the vibration detecting unit in an exposure period of the image pickup unit;
an image restoration unit which restores the image data deteriorated by the vibration based on the image restorative function output from the image restorative function calculating unit;
a recording mode selection unit to select a first recording mode to record, in a recording medium, the image data which is not subjected to an image restoration process by the image restoration unit and image restoring information corresponding to the image data, and a second recording mode to record the restored image data subjected to the image restoration process by the image restoration unit in the recording medium; and
an image recording controller which records the image data which is not subjected to the image restoration process and the image restoring information in the recording medium in the first recording mode in a case where the first recording mode is selected and which records the restored image data subjected to the image restoration process in the recording medium in the second recording mode in a case where the second recording mode is selected.

2. The image pickup apparatus according to claim 1, wherein the image restoring information includes the vibration detecting signal of the time series.

3. The image pickup apparatus according to claim 1, wherein the image restoring information includes the image restorative function.

4. The image pickup apparatus according to claim 1, wherein the recording mode selection unit further selects a third recording mode in which the image data that is not subjected to the image restoration process is recorded in the recording medium and in which the image restoring information corresponding to the image data is not recorded in the recording medium, and
the image recording controller records the image data in the recording medium in the third recording mode in a case where the third recording mode is selected.

5. The image pickup apparatus according to claim 1, wherein the image recording controller records in the recording medium an image file in which the image data that is not subjected to the image restoration process is assigned to a data portion and in which the image restoring information corresponding to the image data is assigned to a header portion in a case where the first recording mode is selected.

6. The image pickup apparatus according to claim 1, further comprising:
a vibration detecting signal storage unit which stores the vibration detecting signal output from the vibration detecting unit in the exposure period of the image pickup unit,
the image restorative function calculating unit calculating the image restorative function from the vibration detecting signal of the time series stored in the vibration detecting signal storage unit.

7. The image pickup apparatus according to claim 1, further comprising:
a reading unit which reads an image data recorded in the recording medium;
a judgment unit which judges whether or not the image data read by the reading unit is an image data recorded in the first recording mode; and
an operation instructing unit which outputs an instruction signal to restore the image data based on the image restoring information and to record again the restored image data in the recording medium in the second recording mode in a case where the image data is recorded in the first recording mode.

8. The image pickup apparatus according to claim 7, wherein the recording of the restored image data in response to the instruction signal from the operation instructing unit is overwriting.

9. The image pickup apparatus according to claim 7, further comprising:
a display element which displays the image data read by the reading unit; and
a display controller to display in the display element both of the image data read by the reading unit which is not subjected to the image restoration process and the restored image data subjected to the image restoration process, in a case where the image data recorded in the first recording mode is restored and recorded again in the second recording mode in response to the instruction signal from the operation instructing unit.

10. An image pickup apparatus comprising:
an image pickup unit which obtains image data from a subject image formed by an optical system;
a vibration detecting unit which detects a vibration of the image pickup apparatus;
an image restorative function calculating unit which calculates an image restorative function from a vibration detecting signal of a time series output from the vibration detecting unit in an exposure period of the image pickup unit;
an image restoring information storage unit in which image restoring information is stored;
an image restoration unit which restores the image data deteriorated by the vibration based on the image restorative function output from the image restorative function calculating unit;
an image data storage unit to store the image data which is obtained from the image pickup unit and which is not subjected to the image restoration process by the image restoration unit;
an image recording controller which controls to record in a recording medium the image data, as an image file, which is not subjected to the image restoration process by the image restoration unit, the image recording controller re-recording a restored image data subjected to the image restoration process by the image restoration unit based on the image data which is not subjected to the image restoration process and the image restoring information stored in the image restoring information storage unit after the image data is recorded in the recording medium; and
an operation instructing unit which outputs to the image recording controller an instruction signal to record the restored image data again.

11. The image pickup apparatus according to claim 10, wherein the recording of the restored image data in response to the instruction signal from the operation instructing unit is overwriting.

12. An image pickup apparatus comprising:
an image pickup unit which obtains image data from a subject image formed by an optical system;
a vibration detecting unit which detects a vibration of the image pickup apparatus;
an image restorative function calculating unit which calculates an image restorative function from a vibration detecting signal of a time series output from the vibration detecting unit in an exposure period of the image pickup unit;
an image restoration unit which restores the image data deteriorated by the vibration based on the image restorative function output from the image restorative function calculating unit;
an image data storage unit to store the image data which is not subjected to an image restoration process by the image restoration unit;
an image recording controller which records the restored image data subjected to the image restoration process by the image restoration unit as an image file in a recording medium, the image recording controller re-recording the image data which is not subjected to the image restoration process in the recording medium after the restored image file is recorded in the recording medium; and
an operation instructing unit which outputs to the image recording controller an instruction signal to record the image data again.

13. The image pickup apparatus according to claim 12, wherein the recording of the image data in response to the instruction signal from the operation instructing unit is overwriting.

14. An image pickup apparatus comprising:
an image pickup unit which obtains image data from a subject image formed by an optical system;
a vibration detecting unit which detects a vibration of the image pickup apparatus;
an image restorative function calculating unit which calculates an image restorative function from a vibration detecting signal of a time series output from the vibration detecting unit in an exposure period of the image pickup unit;
an image restoration unit which restores the image data deteriorated by the vibration based on the image restorative function output from the image restorative function calculating unit;
a display element which displays the image data; and
a display controller which controls to display in the display element both of the restored image data subjected to the image restoration process by the image restoration unit and the image data which is not subjected to the image restoration process.

15. The image pickup apparatus according to claim 14, further comprising:
a vibration detecting signal storage unit which stores a vibration detecting signal of a time series output from the vibration detecting unit in an exposure period of the image pickup unit,
the image restorative function calculating unit calculating the image restorative function from the vibration detecting signal of the time series stored in the vibration detecting signal storage unit.

16. The image pickup apparatus according to claim 14, wherein the display controller displays a same area of a predetermined part of the whole area of the image data and the restored image data in a case where there are displayed in the display element both of the restored image data and the image data.

17. The image pickup apparatus according to claim 16, wherein the same area of the predetermined part is an area of the center of the whole area of the image data and the restored image data.

18. The image pickup apparatus according to claim 16, further comprising:
an image selection unit which selects the same area of the predetermined part from the whole area of the image data and the restored image data.

19. The image pickup apparatus according to claim 14, wherein the display controller displays in parallel the restored image data and the image data.

20. The image pickup apparatus according to claim 14, wherein the display controller switches and displays the restored image data and the image data.

21. The image pickup apparatus according to claim 14, wherein the display controller tentatively displays in the display element the image data which is not subjected to the image restoration process by the image restoration unit, and the display controller switches the display element to display in parallel the restored image data and the image data after the image restoration process is completed by the image restoration unit.

22. The image pickup apparatus according to claim 21, wherein the display controller switches the display element to display the restored image data only after elapse of a predetermined time after the display element is switched to display in parallel the restored image data and the image data.

23. An image pickup apparatus comprising:
an image pickup unit which obtains image data from a subject image formed by an optical system;
a vibration detecting unit which detects a vibration of the image pickup apparatus;
an image restorative function calculating unit which calculates an image restorative function from a vibration detecting signal of a time series output from the vibration detecting unit in an exposure period of the image pickup unit;
an image restoration unit which restores the image data deteriorated by the vibration based on the image restorative function output from the image restorative function calculating unit;
a display element which displays the image data;
a data storage unit to store both of the restored image data subjected to the image restoration process by the image restoration unit and the image data which is not subjected to the image restoration process;
a display controller which controls to display in the display element both of the restored image data stored in the data storage unit and the image data stored in the data storage unit;
an image selection unit to select one of the restored image data and the image data; and
a recording controller which records the image data or the restored image data selected by the image selection unit in a recording medium.

24. The image pickup apparatus according to claim 23, wherein the display controller displays in parallel, in the display element, both of the restored image data and the image data.

25. The image pickup apparatus according to claim 23, wherein the display controller switches to display in the display element both of the restored image data and the image data.
